(19) United States
(12) Patent Application Publication
(10) Pub. No.: US 2021/0263346 A1
(43) Pub. Date: Aug. 26, 2021

(54) Digitally Reconfigurable Neutral Density Filter

(71) Applicant: Gary Sharp Innovations, LLC, Boulder, CO (US)

(72) Inventor: Gary D Sharp, Boulder, CO (US)

(21) Appl. No.: 17/184,492

(22) Filed: Feb. 24, 2021

Related U.S. Application Data
(60) Provisional application No. 62/980,877, filed on Feb. 24, 2020.

(51) Int. Cl. G02F 1/01; G02F 1/137; G02F 1/13363

(52) U.S. Cl. CPC G02F 1/0136; G02F 1/137; G02F 1/133634; G02F 2413/13; G02F 2413/02; G02F 2413/14; G02F 1/133638

(57) ABSTRACT

A digital neutral density (DND) filter that provides rapid reconfiguration between discrete density states using electro-optic devices such as liquid-crystal cells. Each filter stage may be dedicated to binary switching between a high-transmission state (giving minimal loss) and one or more prescribed densities in a filtering state. The design prescription may “hard-wire” a stage to produce switching between an all-pass filter and a prescribed filter density. Design parameters can be used to assign specific densities to each stage. Multiple stages can be cascaded to provide a plurality of discrete density values. Such DND filters can sacrifice analog tunability in order to optimize uniformity in color and transmission over a wide range of incidence angles.

### CROSS-REFERENCE

This application claims priority to U.S. Provisional Application No. 62/980,877 filed Feb. 24, 2020, the contents of which are incorporated herein by reference in its entirety.

### BACKGROUND

Neutral density filters are used routinely in still and video image capture applications, particularly outdoors where brightness can be extremely high. High quality passive neutral density filters can perform very well in terms of uniformity in transmission/color over incidence angle. Filter kits are available and filters can be stacked using various fixtures, providing a broad range of discrete density levels. However, the user must make a “best guess” as to the appropriate filter for the environment. The environment can of course have a high degree of temporal variation (e.g., clouds temporarily occluding the sun). The mechanism for changing such a filter is manual, and thus cumbersome, slow, and inconvenient. Moreover, changing filters in a dynamic setting where the camera is not easily accessible (e.g., a drone or action video camera) can be particularly problematic.

Variable neutral density (VND) filters typically include a pair of polarizers, where one is rotated with respect to the other to control the transmission level. This has the benefit that a single filter unit can be made to provide analog transmission over a broad range of densities. Moreover, an electromechanical tuning mechanism can enable closed-loop density reconfiguration for remote and hands-free operation. Polarizer-based VNDs are limited in reconfiguration speed by the tuning mechanism (e.g., a motor). Two-polarizer configurations typically have angular transmission artifacts (due to geometric rotation of the polarizer absorption axes) which become worse at shorter focal lengths and/or when the density is increased. A new version of this (Sharp and McGettigan, US 20180259692, the contents of which are incorporated herein by reference), which uses multiple stages that can open in a “fan” arrangement mitigates this artifact, allowing much better performance over wide angle and dynamic range.

Another form of VND filter is electro-optical, using (e.g.) liquid crystal devices to change density. Functionally, LC devices are typically used to introduce a voltage-controlled phase-difference (aka retardation) as a means of changing the state-of-polarization upstream of an analyzing polarizer.

Alternatively, they may use (e.g.) a guest-host LC material to behave as a variable polarizer (Osterman, U.S. Pat. No. 9,933,631). In some applications (e.g., intra-frame modulation of density for temporal apodization, e.g., Davis, U.S. Pat. No. 10,187,588), rapid tuning and the lack of moving parts may be advantageous relative to electro-mechanical means. Significant progress has been made in recent years to produce LC VND filters with angle-insensitive density/color and sufficient range in tuning density. However, the ability to maintain uniform transmission and color over a very wide angle and over a significant range of densities, can be extremely challenging for LC devices operated in an analog mode. This may constrain the physical location of the filter in the optical train, for example between the lens and the image capture device where light is more collimated. This may not be practical in some instances, and it may also introduce performance tradeoffs.

There remains a need for a rapidly reconfigurable ND filter that operates over a wide dynamic range (e.g., >5 stops) and wide acceptance angle (e.g., >80° angle of view (AOV)) without introducing significant image artifacts.

It is against this background that the present invention has been created.

### SUMMARY

The invention uses switchable polarization control elements (e.g., liquid-crystal (LC) devices) to enable rapid reconfiguration of a neutral density filter. The described digital neutral density (DND) filters abandon the flexibility of analog modulation for the purpose of obtaining high-performance over wide-angle for a discrete set of density settings. As such, the invention could be considered analogous to a set of ND filters that can be swapped/stacked in the conventional way, but with a single monolithic unit, no moving parts, and the benefits of rapid switching. The described filter architecture avoids situations in which the switch(es) can introduce transmission nonuniformity artifacts when operated over the full range of densities, particularly for the shortest focal-length lens requirement.

The invention recognizes that single-domain LC devices operated in an analog mode (e.g., anti-parallel nematic electrically controlled birefringence (ECB), and vertical alignment (VA)) can exhibit poor angular performance. This applies particularly to voltage settings in which the director-field (i.e. the distribution of anisotropic molecules in the LC volume) is substantially oblique (i.e. intermediate between in-plane and normal to the substrate). In a worst-case scenario, the LC device may exhibit a first-order (i.e. linear) shift in retardation with respect to incidence angle. In such cases, there can be a high degree of asymmetric angular nonuniformity in density that can render a particular setting useless in practice. The invention seeks to leverage switching between director field distributions that are either substantially in-plane, or substantially normal to the cell substrates, and that both states exhibit second-order dependence of retardation on incidence angle. The invention thus uses the two voltage states in which the polarization optic delivers the best performance in terms of stability of the polarization transformation with respect to incidence angle.

For applications requiring the highest angle-of-view (AOV), the invention further recognizes the value of using LC device configurations that exhibit zero phase-difference (retardation) in the thickness direction (proportional to thickness direction pathlength difference, Rₜₕ) in both voltage states. Such devices are described in co-pending application Sharp, US 20190353948, the contents of which are hereby incorporated by reference.

The invention recognizes that the burden of full analog modulation from a single LC VND stage over a wide density range can be excessive, with performance over angle typically suffering. In order to achieve multiple density settings using the invention, the filter architecture can employ filter stages with switches operated independently in each stage. The invention can distribute the system-level density over a plurality of lower-density digital filter stages, thereby relieving the requirements from a particular stage. This can create an opportunity to optimize the AOV performance using a stage operated at a reduced density. For instance, a three-stage filter may have Stage 1 switching between 0-stops and 1-stop of attenuation, Stage 2 switching between 0-stops and 2-stops of attenuation, and Stage 3 switching between 0-stops and 4-stops of attenuation. The result is a DND filter that can switch between 0-stops and 7-stops of attenuation in 1-stop increments.

### BRIEF DESCRIPTION OF THE DRAWINGS

FIG. 1. (A) OFF-State, and; (B)ON-State configuration of a prior-art single-stage LC ND filter.

FIG. 2. Off-normal behavior of the switch of FIG. 1A, in; (A) the 0-azimuth, and; (B) the 45°-azimuth.

FIG. 3. Off-normal behavior of the switch of FIG. 1B, in; (A) the 0-azimuth, and; (B) the 45°-azimuth.

FIG. 4. (A) OFF-State, and; (B)ON-State configuration of a prior-art single-stage LC switchable ND filter with zero-Rₜₕ.

FIG. 5. Off-normal behavior of the switch of FIG. 4A, in; (A) the O-azimuth, and; (B) the 45°-azimuth.

FIG. 6. Off-normal behavior of the switch of FIG. 4B, in; (A) the O-azimuth, and; (B) the 45°-azimuth.

FIG. 7. (A) OFF-State, and; (B)ON-State configuration of a single-stage LC switchable ND filter of the invention, with zero-Rₜₕ.

FIG. 8. Off-normal behavior of the switch of FIG. 7A, in; (A) the O-azimuth, and; (B) the 45°-azimuth.

FIG. 9. Off-normal behavior of the switch of FIG. 7B, in; (A) the O-azimuth, and; (B) the 45°-azimuth.

FIG. 10. (A) Insertion of geometric compensators into the filter stage of FIG. 7A; (B) OFF-State of the filter-stage of FIG. 10A with excess C-Plate retardation removed, and; (C)ON-State of the filter stage of FIG. 10B.

FIG. 11. OFF-State transmission of a light-shutter using the configuration of FIG. 10B at 45° AOI and the worst-case azimuth)(0/90° and; ON-State transmission of a light-shutter using the configuration of FIG. 10C at normal incidence and at 45° AOI for several azimuth angles.

FIG. 12. Configuration of a fully-compensated parallel-polarizer DND stage of the invention, providing; (A) an unfiltered state (with zero attenuation at all wavelengths), and; (B) a filtered-state with 1-Stop of attenuation.

FIG. 13. Transmission spectra for, (A) the unfiltered-state, and; (B) the filtered-state for the 1-Stop DND configuration of FIG. 12. The transmission in the unfiltered state is substantially independent of AOI. FIG. 13B shows an overlay for the case of normal-incidence, and for an AOI of 45°, in 45° increments of azimuth.

FIG. 14. Configuration of a fully-compensated crossed-polarizer DND stage of the invention, providing; (A) an unfiltered (zero-order half-wave) state, and; (B) a filtered (quarter-wave) state with 4-Stops of attenuation.

FIG. 15. Transmission spectra for, (A) the unfiltered-state, and; (B) the filtered-state for the configuration of FIG. 14. Each of the former shows an overlay for the case of normal-incidence, and for an AOI of 45°, in 45° increments of azimuth.

FIG. 16. (A) OFF-State, and; (B)ON-State configuration of a wide-angle achromatic rotator switch of the invention used as a high-contrast light shutter.

FIG. 17. Transmission spectra for, (A) the OFF-State, and; (B) the ON-State for the configuration of FIG. 16. FIG. 17A shows the 45° AOI transmission at the worst-case azimuth angles (0/90°), where the transmission is virtually zero in the ±45° azimuth. FIG. 17B shows the transmission at several azimuth angles.

FIG. 18. General configuration for a DND filter stage of the invention using a wide-angle achromatic rotator switch, where density is determined by relative polarizer angle. FIG. 18A shows the unfiltered state, where the rotator converts the SOP, and FIG. 18B shows the filtered state, where the switch has zeroRₑ.

FIG. 19. Transmission spectra for the (A) unfiltered and (B) filtered states of a 1-Stop DND filter stage of FIG. 18 at normal incidence, and at 45° AOI in 45° increments of azimuth.

FIG. 20. General DND filter of the invention, including one or more independent switches per stage and a plurality of filter stages.

FIG. 21. Azimuthal variation in transmission at 45° AOI for the four polarizer arrangements available in a three-stage DND using 1-stop, 2-stop and 4-Stop stages.

FIG. 22. A preferred arrangement for a three-stage DND using 1-stop, 2-stop and 4-Stop stages.

FIG. 23. Normal incidence transmission spectra for the eight outputs of the DND design of FIG. 22 using the stage designs of FIG. 18.

FIG. 24. A zero-Rₜₕ polarization switch of the invention combined with an achromatic quarter-wave retarder to produce a circular polarization handedness switch.

FIG. 25. Block diagram for a DND used in an image capture system with closed-loop control.

### DETAILED DESCRIPTION

### Definition of Terms used in the Specification

Some of the vocabulary used in this specification is unique to this type of filter. Additionally, there may be different interpretations of the precise definition of some more common industry terms. In the interest of clarity, the following is a list of definitions for important terms and metrics used throughout the specification.

Neutral Density Filter: A neutral density filter is an optical component that transmits light with a prescribed level of attenuation and with wavelength insensitivity. Attenuation is quantified herein in terms of “stops”, consistent with terminology used in image capture. The attenuation in stops is calculated as the base-two logarithm of the inverse of the power transmission function. Thus, 1-stop of attenuation is equivalent to 50% transmission, 2-stops of attenuation is equivalent to 25% transmission, 3-stops of attenuation is equivalent to 12.5% transmission, and so-on. In the context of visible filters, the attenuation is given by assuming a flat input spectral-power-distribution (SPD) and calculating the ratio of lumens transmitted by the filter to that in the absence of the filter.

The term “neutral” is somewhat subjective and application-specific, referring to an allowed degree of wavelength dependence in attenuation over a defined spectral range of interest. In the context of the visible spectrum, the term “achromatic” may be applied equivalently. An ideal neutral density refers to an attenuation that is spectrally flat; a solution that is most broadly applicable in practice. The term neutral may be expanded to include filters that tolerate an incremental color-shift at normal incidence and/or a shift in color that depends upon incidence angle. The latter is defined below as color-nonuniformity.

Filter Stage: In this context, a filter stage is a stand-alone unit capable of providing two or more density values. Filter stages interact on a power basis, such that the composite transmission is given by the product of the transmission function of each filter stage. A variable neutral density (VND) filter can be implemented in a single filter stage. A digital neutral density (DND) filter of the invention may preferably use two or more stages to generate more than two density values. The analyzing polarizer from one stage typically serves as the input polarizer for the subsequent stage. A DND with more than two density states can be realized with a single filter stage containing two or more digital electro-optic devices. In the latter case (e.g., Sharp US 20190353948, the contents of which are incorporated herein by reference) the state of polarization resulting from the plurality of switches is converted to a plurality of density values using a single polarization analyzer.

Variable Neutral Density (VND) Filter: A VND filter is a neutral density filter with analog tunability over a prescribed range of densities. A VND filter may use mechanical (or electro-mechanical) tuning, or electro-optic tuning. The former may involve rotation of one polarizer with respect to another, and the latter may refer to the application of an electric field to one or more electro-optic devices.

Digital Neutral Density (DND) Filter: A DND is a neutral density filter that switches between discrete density states, using digitally driven electro-optic devices. In an arrangement of the invention there are two or more filter stages used to create multiple states, where each stage has one (or more) electro-optic devices switched between two states. A DND filter may have two or more electro-optic switching devices, where the number of density values can scale as large as 2^{N}, where N is the number of independent electro-optic switches.

Angle-of-View (AOV): In this context, AOV refers to the full-cone angle of light incident on the filter (with respect to the surface normal) in which performance is deemed acceptable over all azimuth angles. In the context of a VND or DND, it further includes the full range of filter densities. The AOV is subject to acceptance criteria for density/color nonuniformity. For instance, it may be stated that a particular VND has a 90° AOV, subject to a 0.5-stop density nonuniformity and an allowed maximum shift in color coordinates, or color nonuniformity. The desired AOV in image capture is typically determined by the shortest anticipated focal-length of the lens and the diagonal dimension of the image-capture device. For instance, a full-frame image sensor used with a 24 mm focal length lens may have a desired AOV of 84°.

Insertion Loss: This is the transmission loss of a VND or DND when set to the lowest density value, specified in terms of stops. For example, in a two-polarizer VND, the insertion-loss is measured when the polarizer absorption axes are parallel. Given that the input is virtually unpolarized, the example VND has a 1-stop loss associated with creating a polarized state, with (typically) an additional 0.5-stop loss associated with absorption/reflection by elements of the VND (e.g., absorption orthogonal to the polarizer absorption axes and Fresnel reflections). It is therefore common for an exemplary polarizer-based VND to have a net 1.5-stop insertion loss.

Dynamic Range: This refers to the (normal incidence) difference between the maximum density setting and the minimum density setting of a VND or DND, specified in terms of stops. For example, in a two-polarizer VND that can be rotated between hard-stops associated with parallel polarizers (0-Stops), and polarizers with absorption axes at 82.8° (6-stops), the dynamic range is 6-Stops. Note that the dynamic range is independent of insertion loss, though the actual densities produced by a VND/DND are given by adding the density setting to the insertion loss (in stops). In this example, the 82.8° setting corresponds to an attenuation of 7.5-Stops when insertion loss is included.

Density Nonuniformity: This is defined as the absolute value of the difference between the minimum transmission (in stops) and the maximum transmission (in stops) for any light incident within the AOV. It can be calculated using the transmission at a single wavelength, or it can be calculated by integrating the photopically-weighted transmission over the input SPD. As described above, the density is given as the ratio of lumens transmitted by the filter to that incident, subject to an input SPD. The density nonuniformity is obtained by computing the latter (assuming a flat-top input SPD) with a representative sampling of AOI and azimuth angles that resolves the features, and then locating the high and low values for density nonuniformity calculation.

Color Nonuniformity: This is defined in terms of the maximum rms difference between any two color coordinates (e.g., a*b*, u′v′, etc) associated with the transmission function of the VND/DND over the AOV, assuming a flat-top input SPD. In an active device, each density state may have a unique color nonuniformity, where the AOV may be limited by the filter state exhibiting the highest angular sensitivity in transmitted color. Note that color nonuniformity does not account for the actual tint of a density state, only the shift with respect to angle. The filter tint is captured by the specification for neutrality, as discussed above.

Polarizer: There are several types of polarizers, but the most common is a stretched-PVA iodine/dye-stuff type. These are linear polarizers with a uniaxial absorption axis in the stretching direction (in-plane), so they are termed o-type polarizers because they transmit the ordinary wave. Liquid-crystal based polarizers have also been demonstrated that are e-mode type, so they transmit the extraordinary mode.

Retarder: A retarder is also called a phase-difference film. It is an anisotropic (uniaxial or biaxial, positive or negative anisotropy) dielectric, such as a stretched polymer, a cross-linked reactive mesogen, or an active liquid-crystal device. Most stretched polymer retarders have their refractive indexes in the principal coordinate system of the film (i.e. two in-plane refractive indexes and one thickness-direction refractive index). Uniaxial retarders can be produced by uniaxial in-plane stretching (aka a positive A-Plate), where the slow-axis typically corresponds to the stretching direction. A negative uniaxial retarder has an optic axis representing the fast-axis. Biaxial retarders can be produced by biaxial stretching (e.g., orthogonal in-plane stretching or in-plane stretching combined with thickness direction stretching). For instance, biaxial in-plane stretching can produce zero in-plane pathlength-difference (Rₑ) resulting in only thickness direction pathlength-difference (Rₜₕ) (aka a negative C-Plate). Retarders have dispersion, which typically introduces additional chrominance, though there are more achromatic retarders exhibiting “reverse dispersion” in phase-difference. For the latter, pathlength difference increases with wavelength.

Liquid crystal devices (active or RM) can have additional degrees of freedom relative to stretched films. Because liquid crystal devices are generally inhomogeneous (at least in the thickness direction), they are typically analyzed as a stack of thin layers, each with a homogeneous director distribution. Various types of RM and active LC alignments are common, including splays, bends, and twists about the surface normal. As in active devices, pretilts can be introduced when needed. In this context, retarders are used to transform a state-of-polarization, where an analyzer (polarizer) is ultimately needed to convert SOP to a density.

Oblique Anisotropy: This refers to optically uniaxial (or biaxial) material with an optic axis tilted with respect to the surface normal. A uniaxial retarder with substantially intermediate tilt (e.g., 45°) can introduce first-order retardation with respect to incidence angle. This can result in relatively large asymmetric transmission of a filter stage with respect to incidence angle. An oblique polarizer (e.g., guest-host LC) may have an absorption axis which is tilted with respect to the surface normal with related issues. Oblique anisotropy can exacerbate angular variations in (wavelength dependent) phase-difference and projected optic axis orientation, which is generally undesirable in the present invention.

In-Plane Pathlength Difference: Denoted “Rₑ”, this refers generally to the net optical pathlength difference projected onto the substrate plane. Retardation is the ratio of Rₑ to wavelength, multiplied by 2π. In the context of preferred anisotropic materials used for exemplars of the invention, it refers to anisotropic material aligned with the principal axes of the retarder film. With this constraint, the in-plane retardation is the phase-difference resulting from the two in-plane refractive indexes. A “composite Rₑ” can be associated with a retarder stack. Note that the situation is more complex when using (e.g.) twisted LC structures where the optic axis orientation is inhomogeneous.

Thickness Direction Pathlength Difference: Denoted “Rₜₕ”, this refers generally to the optical pathlength difference projected onto the substrate normal. In the context of preferred anisotropic materials used to demonstrate the invention, Rₜₕ refers to anisotropic materials aligned with the principal axes of the retarder film. Rₜₕ in this context is given by the difference between the thickness direction refractive index and the average of the in-plane refractive indexes, multiplied by thickness. Each polarization optic can have an Rₜₕ value, and a stack of two or more polarization control elements (e.g., retarders and LC devices) can have a “composite Rₜₕ” which represents the accumulation of Rₜₕ.

Note that the composite Rₜₕ is not always obtained by adding the Rₜₕ of each element, since the azimuthal distribution of retarders can affect the accumulation of Rₜₕ (see for example Sharp US 20190018177, the contents of which are incorporated herein by reference). According to the invention, it is a general objective to drive the composite Rₜₕ to zero for all states of a DND.

Geometric Compensation: Denoted GC, this refers to one or more passive retarder films that only perform a polarization transformation for light incident off-normal. GC is effectively a polarization rotation (or polarization reflection) that counteracts a geometric rotation experienced by off-normal rays. For example, the orientation of a vector in one reference frame (e.g., the absorption-axis of a polarizer/slow-axis of a retarder in the substrate plane) changes when it is projected onto another reference frame (e.g., the plane normal to the ray-vector (or k-vector)). An ideal GC preserves the normal-incidence function of the in-plane arrangement of polarization optics for off-normal rays in the presence of geometric rotation.

Intra-Stage Compensation: This refers to an arrangement of elements in a stage that collectively minimizes transmission nonuniformity and color nonuniformity over angle. That is, intra-stage compensation endeavors to preserve the normal-incidence transmission function at large angles of incidence. Since this represents the interaction of light with elements within the stage on a field-basis, it is synonymous with stabilizing Rₑ and minimizing composite Rₜₕ and geometric effects over incidence angle. These are key elements of the invention for producing building blocks that individually perform well over angle.

Inter-Stage Compensation: This refers to an arrangement of filter stages that collectively minimizes transmission nonuniformity and color nonuniformity within the AOV. Since stages interacted on a power transmission basis, this refers to a complementary arrangement of two (or more) stage transmission functions, such that the AOV is optimized. Optimization may refer to transmission uniformity and/or color uniformity over angle.

ON/OFF-State: There are many configurations of electro-optic devices, which can be grouped into two categories. In one category, the device delivers a relatively small Rₑ value when unenergized (e.g., VA), and a relatively large Rₑ value when energized. In another category, the device delivers a relatively large Rₑ value when unenergized (e.g., TN, ECB, pi-cell), and a relatively small Rₑ value when energized. In some preferred arrangements, the devices are driven such that one Rₑ value is virtually zero, while the other Rₑ value converts light from one SOP to the orthogonal SOP (e.g., a half-wave). For the sake of clarity, the ON-State will be considered the state with relatively large Rₑ and the OFF-State will be considered the state with relatively small Rₑ. The latter applies both to single LC devices and to the LC-pairs of the invention.

Definition of Problem

The ability to adjust the light level reaching an image sensor independent of the aperture is highly valuable for optimizing still/video image quality, particularly in outdoor settings with a short focal length. The most common solution is to carry a set of neutral density filters, each with a unique density. Density changes can be accomplished by manually unthreading a filter from the lens housing and replacing it with one more suited to the ambient luminance and the desired result. Alternatively, filter tray fixtures allow filters to be easily inserted/removed in combinations. Other density values can thus be obtained by stacking filters (e.g., a set of three filters can in principle produce eight outputs. In this example, the lowest density omits filtration, and the highest density stacks all three filters. The latter represents the dynamic-range of the filter. In the case of a geometric series of densities (e.g., a set including 1, 2 and 4 stop ND filters), the dynamic range can be 7-stops, in 1-stop increments. This example can be considered a crude digital neutral density (DND) filter in the sense that the scheme permits switching between a discrete set of fixed densities. It is obviously slow, cumbersome, requires manual access to the lens and filter set during any density changes, and does not allow analog density setting. But because of the high quality available with passive ND filters, it is often preferred because it can be used at any focal length without concern for artifacts associated with angular variations in transmission and color. Furthermore, the settings are well defined by the fixed density values.

An analog (e.g., manual) version of this is the VND filter using a pair of neutral polarizers. As in the above example, reconfiguration is slow and requires manual access to the lens. The common two-polarizer version enables analog tunability, though it trades this convenience for angle artifacts (e.g., the “dreaded-X”) which precludes high densities particularly when shooting at shorter focal lengths. This situation is improved when using the “fan” arrangement of polarizers, described in US 20180259692, including two or more filter stages using inter-stage compensation for angular artifacts.

There are also non-mechanical versions of the VND/DND. Generally, these use some form of electro-optic (e.g., liquid-crystal (LC)), piezo-electric, or electro-chromic devices), or optically-addressed devices (e.g., photo-chromic materials) to reconfigure the density. For rapid low-voltage reconfiguration, LC-based ND filters are desirable. They can be broken into two categories; Type 1, which uses active polarization control (e.g., an active retarder) in combination with a passive polarization analyzer, and; Type 2 which merges these functions such that an LC device is itself an active polarizer (e.g., guest-host LC). A simple Type-1 filter stage may include an input polarizer, an appropriately oriented analyzing polarizer, an active LC device that can manipulate the input SOP, and one or more passive phase-difference films as required by the design. Regardless, most active LC devices (e.g., nematics) tend to have an analog response to an applied electric field, and therefore can in principle enable a VND function. For example, a single nematic LC device (TN, VA, ECB, pi-cell) between crossed linear polarizers may perform sufficiently well as a VND when used in collimated light. But in image capture, an ND filter threaded onto a camera lens may have an AOV requirement of 40°, 60°, 80°, and even greater than 100°. The simple LC VND as described has limited practical utility even at the smallest of these angles.

The expectation of using one or more analog driven LC devices to produce an analog ND filter may be unrealistic in ultra-wide AOV situations due to the interferometric nature of Type 1 filtering. That is, AOI-dependent changes in phase-difference, amplitude-splitting, and analyzer orientation can distort the transmission and color relative to the normal-incidence transmission. An engineered normal-incidence composite Rₑ value can be highly distorted when a ray travels at an oblique angle through the filter due to various phenomena that are considered in this disclosure. In some cases, it may be possible to characterize the behavior of a reconfigurable ND filter in each density setting, and over angle, in order to correct for angular artifacts in post-processing. However, there are limits to the range over which this can be accomplished. In an extreme example, the transmission of one or more primary colors may be completely blocked due to such a distortion; a case that clearly cannot be fixed in post-production.

It should further be noted that the interferometric nature of Type 1 filter stages may produce undesirable transmission characteristics even under the best of circumstances (i.e. at normal-incidence). This is because of the phase-difference dispersion of typical LC devices between polarizers, owing to inverse-wavelength dependence and reduced birefringence with wavelength. Transmission spectra may exhibit a shift toward the blue or amber that may be acceptable in some electronic capture applications, so long as the color is angle-stable.

Because of the nonlinear behavior of AOV-limiters with incidence angle, a particular phenomenon that has no material impact on performance at lower incidence angles can become the performance limiter at higher incidence angles if not properly attended to. It is essentially the “onion-peeling” problem, where the designer is granted visibility into the next underlying issue limiting AOV as a reward for addressing higher-significance issues. Once observable, the challenge is to identify a technique for peeling the next layer of the onion. The following describes a specific prioritization for addressing such issues, and ways in which the invention addresses them.
1. Minimize Oblique Anisotropy: An LC device typically modulates the polarization by inducing anisotropic molecules to tilt with respect to the substrate normal with the application of an electric field. When operated in an analog mode, intermediate densities can be obtained using intermediate tilt angles. However, the nonuniformity in VND transmission may be markedly worse at intermediate tilt angles than it is when the molecular director is either entirely in-plane, or entirely normal to the substrate. In one problematic scenario, oblique anisotropy can cause a linear (or first-order) change in retardation with respect to incidence angle. If biased near (e.g.) the 1-Stop transmission point there may be a large associated transmission/color nonuniformity that tends to be asymmetric in angle.
   Techniques using “active compensation” may involve using two analog LC devices to form a single modulator. For example, rotating one ECB by 180° with respect to another, and driving them in tandem (see for example Osterman, U.S. Pat. No. 9,933,631), can improve the situation but it typically does not enable very large AOV. In the previous example, the polarization may be distorted when the plane-of-incidence is orthogonal to that containing the director profiles. In general, oblique anisotropy can result from large pretilt angles (with respect to the substrate or substrate normal), splay at boundaries at low applied voltages, and/or by the deliberate selection of intermediate voltage levels that produce the described intermediate states. The invention minimizes oblique anisotropy of LC/RM devices as follows: (1) Minimize pretilt angles (e.g., 2° or less with respect to the substrate or substrate-normal), and (2) Operate LC cells in binary mode with sufficient voltage to minimize splay. This may entail switching (e.g.) between substantially a positive A-Plate configuration and substantially a positive C-Plate configuration. Note that this does not preclude the use of twisted LC structures so long as oblique anisotropy is minimized. In binary switching, obtaining multiple density states thus requires two or more independently operated binary LC switches. The DND invention thus sacrifices analog density tuning for the sake of maximizing acceptance angle for a discrete set of density values. In terms of complexity, a DND with a wide dynamic range and small density increments may thus have considerably more hardware than a VND counterpart.
2. Minimize Composite Rₜₕ: Under the preferred arrangement that the polarization control elements between the polarizers all have virtually zero oblique anisotropy, the transmission uniformity may be limited by composite Rₜₕ, where Rₜₕ represents a second-order change in retardation with incidence angle. Generally, the widest AOV occurs when the composite Rₜₕ is identically zero. A set of discrete composite Rₜₕ values is associated with switching the one or more LC devices in a DND filter. Because Rₜₕ can be dynamic, the AOV of a DND filter can be limited to the state representing the largest impact of composite Rₜₕ. In one example, the invention seeks to obtain three or more discrete density states using two filter stages, with zero Rₜₕ in each state. An exemplary switch uses a pair of nematic LC devices, driven anti-phase, such that there is no Rₜₕ modulation and each of the two states can be passively compensated to obtain zero composite Rₜₕ. This self-compensating retardation switch, described in US 20190353948, the contents of which are incorporated herein by reference, is a pair of LC cells with the function of a single in-plane switch. For example, a two-stage DND would thus require at least four LC devices. Additional polarization switches with zero-Rₜₕ are described in the present invention.
   Rₜₕ can also be introduced by substrates that, for moderate AOV, are of little consequence. For instance a triacetyl-cellulose (TAC) substrate routinely used for protecting the functional PVA polarizer layer typically has 30-50 nm of negative C-Plate retardation. In an ultra-wide-angle ND filter this can become a performance limiter, necessitating the use of isotropic polarizer substrates.
3. Compensate for Geometric Rotation
   Even in the absence of any composite Rₜₕ, the transmission nonuniformity may be limited by geometric rotation. For instance, the opaque state of a filter stage may have virtually zero Rₑ and zero composite Rₜₕ, yet there is still a transmission nonuniformity. This is essentially the conventional two-polarizer VND, where a cross-pattern (e.g. the “Dreaded-X”) is observed because the polarizer absorption axes appear to counter-rotate when the plane-of incidence-bisects them. Geometric compensation can correct the state of polarization at this azimuth, such that (e.g.) polarizers remain effectively crossed for off-normal rays. This could be in the form of a biaxial HW retarder with Rₜₕ=O oriented with slow axis along one of the absorption axes. It could also be in the form of an A-Plate/C-Plate combination. The +A-Plate may have a slow-axis axis crossed with the absorption axis of the adjacent polarizer, which is followed by a +C-Plate. These two transformations rotate the polarization exiting the first polarizer, with rotation angle increasing with incidence angle in a manner that substantially tracks the increase in geometric rotation angle.
   Geometric rotation is not limited to polarizers. For example, the projected slow-axis of a retarder can also rotate due purely to geometry. Whereas the effect of geometry on a polarizer may be achromatic, it may not be so for a retarder because orientation and phase-difference may be interrelated. The state-of-polarization transmitted by a retarder depends upon phase-difference and the relative amplitude of orthogonal field components, both of which depend upon incidence angle. As stated previously, the output is interferometrically related to the relative amplitude, the pathlength-difference of orthogonal field-components, and the wavelength.
   Managing geometric-rotation can also be enabled by material selection. For instance, geometric rotation occurs when a pair of o-type polarizers are crossed. If the configuration requires zero transmission from the polarizer pair, then the only option is to add GCs. However, if an o-type polarizer is parallel to an e-type polarizer, transmission is also zero but there is no geometric rotation issue. Similarly, if a zero-Rₑ situation is required from a pair of matched+A-plates, they should be crossed and there is a geometric issue that may require GCs. If a positive A-Plate is parallel to a matched −A-Plate, zero-Rₑ is guaranteed because there is no geometric rotation issue. The latter is used in the present invention to obtain an angle-independent filtered state.
4. DND States for Optimum Performance
   It is generally the case that the power transmission of a DND stage is related nonlinearly to the state of polarization (SOP) incident on the analyzer. Consider a simple example of a DND stage including a linear retarder between parallel polarizers, where T=cos²Γ and the retardation is 2Γ. An incremental change in retardation (ΔΓ) experienced by an off-normal ray produces a change in transmission, ΔT=−(sin2Γ)ΔΓ. If the retardation is selected for 1-Stop of attenuation (e.g., Γ=π/4), the associated change in transmission is at a maximum, while that for an all-pass transmission (e.g., Γ=π/2) is at a minimum. The former represents a first-order (i.e. linear) relationship, while the latter is second-order. In this example, a 4% loss in transmission of the all-pass state (i.e. 96% transmission) occurs for a retardation error of 11.54°. However, this same error produces a 19.6% change in transmission when the filter is in the 1-Stop filtered state; a ratio of 5×. The former may be acceptable, while the latter may not be so.
   It may also be the case that a particular DND stage architecture delivers an SOP to the analyzer in one state that is more stable with respect to incidence angle than that of the other state. In this case, the invention attempts to assign the more stable state to the output with the highest sensitivity to distortions in the SOP incident on the analyzer. In the above example, this would be the 1-Stop filtered state. In practice, the invention shows that the more robust state frequently occurs when the polarization switching structure delivers no change in the SOP; that is, it appears isotropic. The architecture for some preferred embodiments may thus deliver the filtered state when the switch vanishes, meaning that some other mechanism is needed to determine the number of stops of attenuation. This may be, in some preferred architectures of the invention, selecting the angle between the polarizer pair to deliver the desired density.
   The above example is not meant to limit the scope of the invention; only to illustrate design considerations of the invention. While the example illustrates the high sensitivity of a stage transmission at 1-Stop (50%) of attenuation, it is important to note that the change in transmission is not the only metric of interest. That is, while the transmission nonuniformity may be highest at 1-Stop, the impact on transmission nonuniformity may be higher when the number of stops of attenuation is higher. For example, at 10-Stops of attenuation there may be a relatively small change in the SOP incident on the analyzer, but if that change drives the transmission to zero the transmission nonuniformity becomes infinite.
5. Cascade Lower Density Stages
   This concept is intimately related to inter-stage compensation, because the density nonuniformity of polarization-based ND filters typically increases with density setting. By using more than one stage, the burden of achieving higher density values can be shared among lower density stages. The DND design may reduce the density of any one stage for the purpose of increasing transmission uniformity. In a preferred arrangement, for instance, an increased transmission from one stage at a particular azimuth coincides with a decreased transmission from another stage, thereby reducing azimuth variation in transmission.

The invention leverages materials and devices that were developed for the flat-panel display industry. Over the years, the level of sophistication and performance of these materials and devices has improved because performance expectations for televisions and monitors has increased. Some of the specifications that are sought, such as high contrast over angle, are relevant to both neutral-density filters and display devices. While solutions are at times relevant, there are departures that tend to make the neutral-density problem more difficult.

In display, the objective is typically to maintain high-contrast, particularly to extreme viewing angles in the horizontal. In ND filtering, it is desirable for the transmission function to have minimal dependence on both AOI and azimuth. Because LC devices are not achromatic in their switching, emphasis in display is given to minimizing transmission in the dark state over angle. The relatively poor spectral performance of the bright-state is less consequential due to the availability of RGB color balancing. A similar function can be provided by post-processing imagery from an image-capture device.

Contrary to optimizing LCD display design, there may be no particular rationale for AOV preference of one DND filter state over another. In a multi-stage DND, the output may be the product of spectra representing stages in both unfiltered and filtered states. As such, a chromatic output can be equally impactful regardless of the state. To the extent that each state represents a valid output, the overall DND AOV may be limited to that associated with the lowest performing state. And because a DND is typically multi-stage, distortions can be compounded if the design is not robust.

Current LCDs achieve uniform neutral gray-levels over angle using spatial methods that may not be relevant to active ND filtering. In one example, a VA device coupled with a −C-plate compensator can have virtually zero Rₑ/Rₜₕ, giving a very dark off-state over a broad AOV (particularly when geometric-compensation is employed). Additionally, azimuthal homogenization of a gray level may be accomplished using multiple domains, a spatial technique that may not be viable for ND filters due to scatter and diffraction artifacts. In a second example, an in-plane switch (IPS) mode is used that minimizes oblique anisotropy, where again, GC can be used to maintain high contrast over angle. However, the IPS-mode requires a sophisticated electrode structure that is practical for pixelated applications, though likely not for ND filters. In summary, both of these spatial methods yield high-performance displays, though their implementation presents challenges for active ND filters. The invention thus seeks architectures using homogeneous materials/devices to provide quality wide-angle all-pass and filtered states.

Filter Examples and Analysis

For the sake of simplicity and consistency of performance comparison in modelling, the filter stage designs are constructed using only exemplary A-Plates and C-Plates. The ordinary/extraordinary refractive indexes of anisotropic media are taken to be 1.50/1.51, respectively, and birefringence dispersion is not included. Polarizers are assumed ideal, in the sense that transmission along the absorption axis is zero and that along the orthogonal direction is unity. Practically speaking, suitable adjustment in parameters is required to obtain an accurate performance prediction using real materials. For instance, a C-Plate retardation may need to be increased to account for a higher index, which decreases the angle in the film. While birefringence dispersion is not included in the model, the wavelength dependence of phase retardation is included, and hence, so is the wavelength dependence of filter transmission. Any accurate performance predictions for (e.g.) an LC-based DND would require inserting actual refractive indexes and LC director profiles.

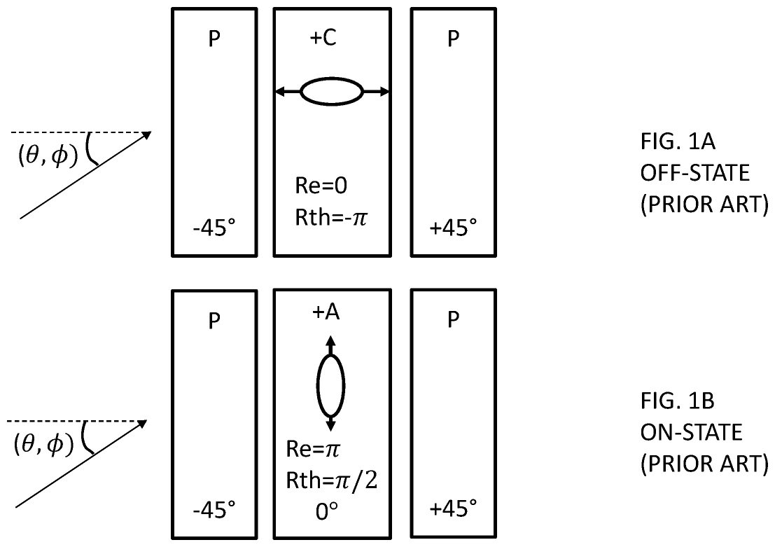

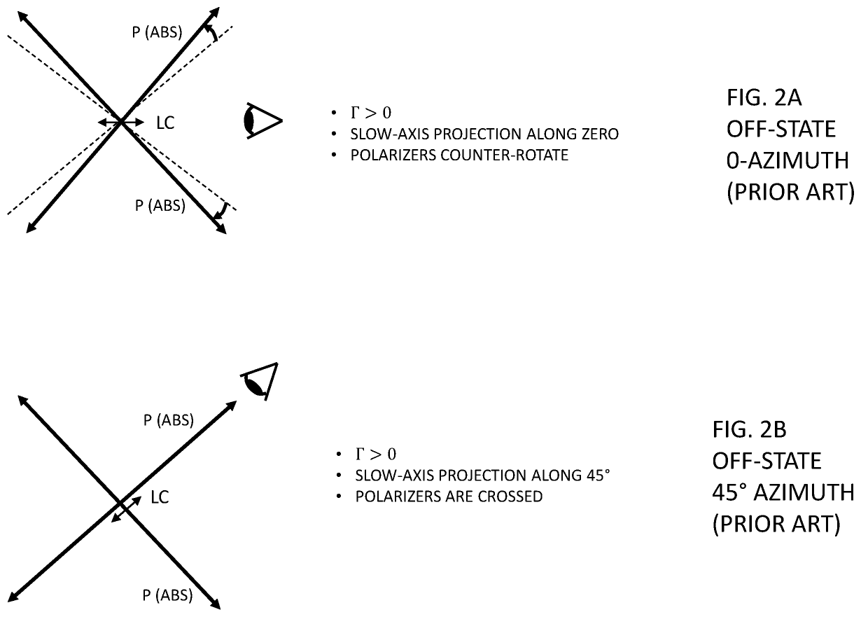

For benchmark purposes, and for illustrating the benefits of DND filter architectures, consider a simplified prior-art single-stage shutter shown in FIG. 1. This shows a pair of crossed polarizers, and a single variable-birefringence LC retarder oriented with slow axis along 0° between them. The retarder is an ideal version of an ECB which switches between; (A) a half-wave C-Plate (OFF-State), with Rₜₕ=−π, and; (B) a half-wave A-Plate (ON-State), with Rₜₕ=π/2. FIG. 2A shows the OFF-State layout of components as observed off-normal along the O-azimuth, and FIG. 2B is that observed along the 45° azimuth. For the former, transmission is non-zero off-normal because there is an in-plane projection of the LC C-Plate that can substantially change the state-of-polarization. Additionally, the polarizer absorption axes appear to counter-rotate due to geometric effects, so they are no longer crossed. For example, at 45° AOI, the photopic transmission is 15% in this plane. If the C-Plate were removed, the geometric rotation would still cause 1.6% transmission at this AOI. Correcting the polarization thus requires a −C-Plate compensator (which if done passively is at the expense of the ON-State AOV), and a geometric rotator. As FIG. 2B shows, the performance in the 45° azimuth is ideal because the polarizers remain crossed and the projection of the LC C-Plate retardation is along a polarizer absorption axis.

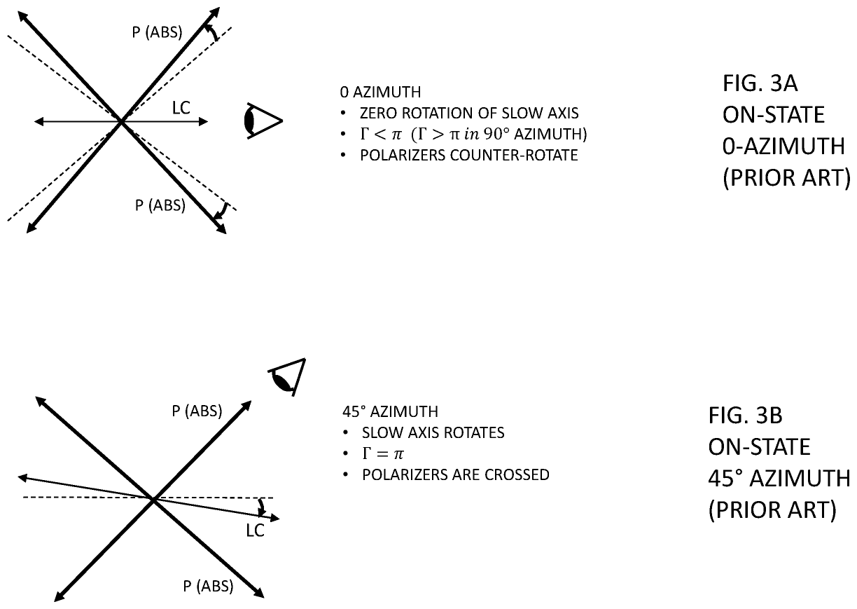

FIG. 3A shows the ON-State layout of components as observed off-normal along the O-azimuth, and FIG. 3B is that observed along the 45° azimuth. At normal incidence, the transmission spectrum peaks at the center wavelength associated with the half-wave retardation. Off-normal, the slow axis refractive index is diminished (due to the projection of the index ellipsoid), and the peak wavelength blue-shifts.

Conversely, the slow-axis index remains fixed in the 90° azimuth, while the increased pathlength causes a red-shift of the peak wavelength. As before, there is a loss in transmission due to the geometric rotation of the polarizers. This spectral shift presents a problem for both transmission and color nonuniformity.

FIG. 3B shows that, as before, the polarizers remain crossed in the 45° azimuth, though there is a geometric rotation of the LC slow-axis. This causes a small loss (2% at 45° AOI) in peak transmission. In this azimuth, there is substantially no change in the retardation of the LC cell.

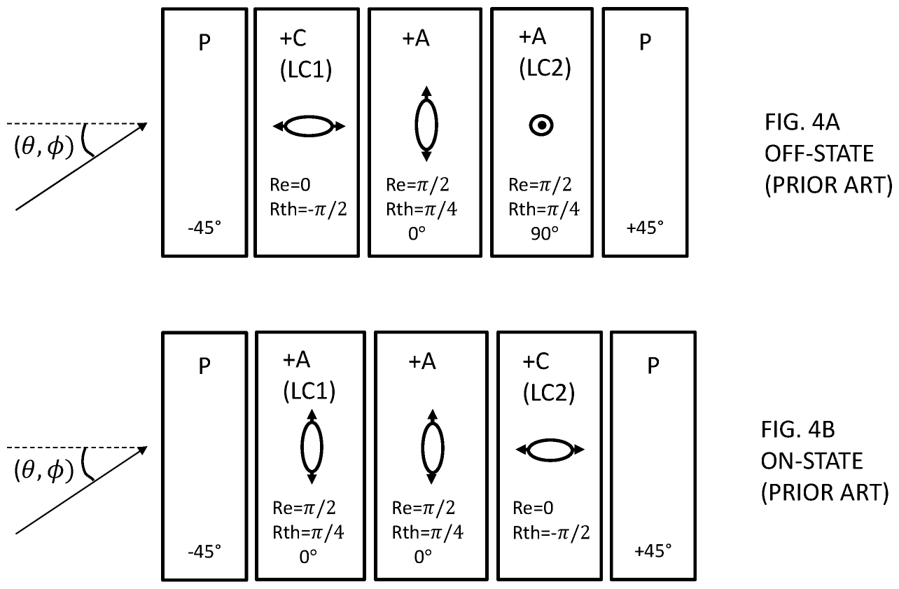

The dominant AOV issue with the above prior art shutter is that the Rₜₕ values in both states are non-zero. As disclosed in the invention by Sharp (US 20190353948, the contents of which are incorporated herein by reference), a dual-LC cell can be used to provide a digital-switch with a constant Rₜₕ in both states. This prior art “self-compensating liquid-crystal retardation switch”, illustrated as a light-shutter, is shown in FIG. 4A (OFF) and FIG. 4B (ON). The complementary A-Plate/C-Plate switching maintains the Rₜₕ of the pair, allowing passive C-Plate compensation to be inserted as needed to minimize composite Rₜₕ. In this example, the Rₜₕ introduced by the +A-Plate retarder accomplishes this.

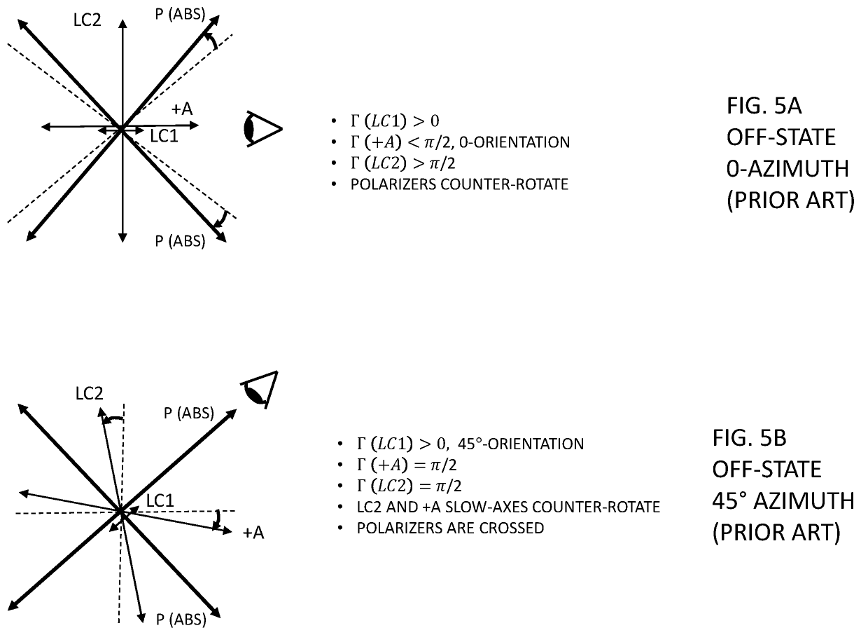

FIG. 5A shows the OFF-State layout of components for the self-compensating LC switch as observed off-normal along the O-azimuth, and FIG. 5B is that observed along the 45° azimuth. For the former, transmission is again non-zero off-normal because of geometric rotation of the polarizers (1.6%). However, because LC1 is driven to a +C-Plate state, the projection of the slow-axis contributes a retardation that is summed with that of a passive+A-Plate with the same orientation. This retardation is crossed with the +A-Plate retardation of LC2, such that the net retardation is virtually zero off-normal. As such, the loss in contrast in this azimuth can be greatly diminished, making the geometric rotation the dominant contrast loss.

FIG. 5B shows that, as before, the polarizers remain crossed in the 45° azimuth. Moreover, the projection of the +C-Plate associated with LC1 is immaterial because it is along a polarizer absorption axis. However, the slow axis of the LC2+A-Plate and the passive+A-Plate are no longer crossed due to geometric counter-rotation, resulting in light leakage.

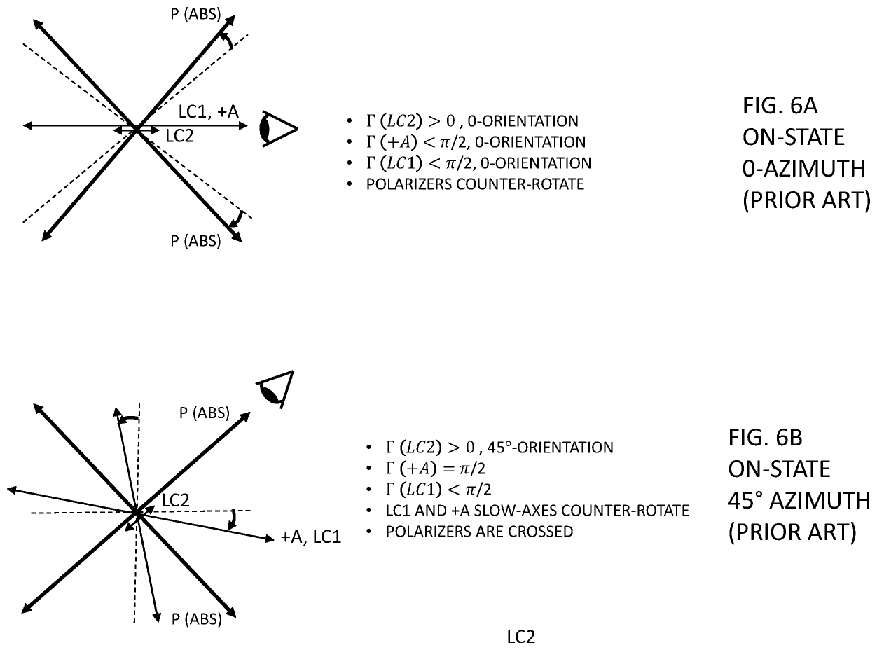

FIG. 6A shows the layout of components for the ON-State of FIG. 4B along the O-azimuth. As before, there is geometric counter-rotation of the polarizers. But the ON-State transmission center-wavelength remains stable because of the compensation that occurs along the viewing direction. That is, the loss in retardation of the pair of A-Plate retarders (LC1 with the passive+A-Plate retarder) is largely offset by the retardation gained from the projection of the +C-Plate retardation associated with LC2.

FIG. 6B shows the layout of components for the ON-State of FIG. 4B along the 45° azimuth. As before, the polarizers remain crossed and the projection of the LC2+C-Plate retardation is immaterial. The counter-rotation of the +A-Plate LC1 retarder and the passive+A-Plate can cause a small loss in transmission because the axes are not in general crossed.

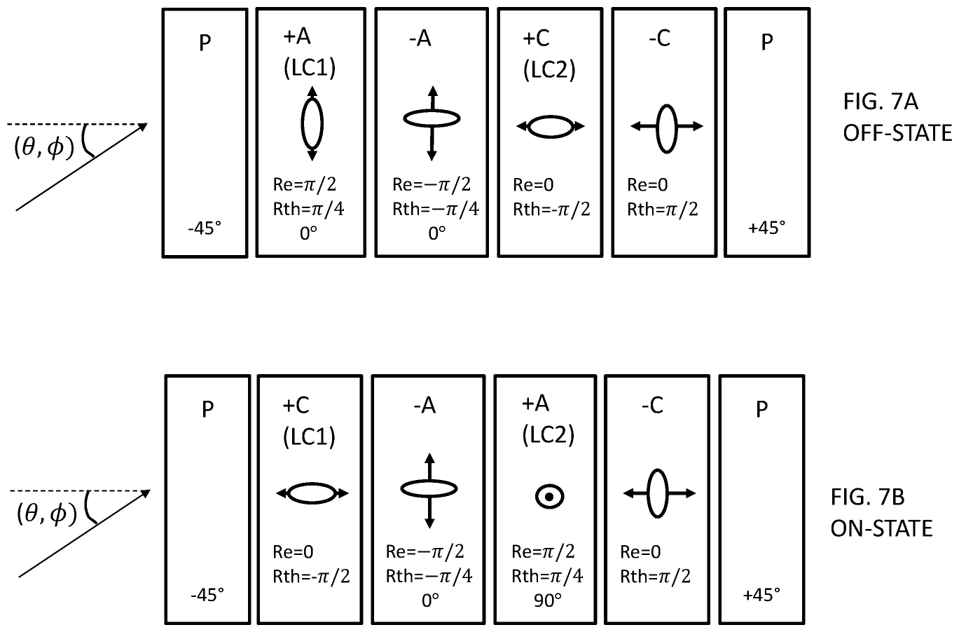

FIG. 7A shows the OFF-State for a shutter of the invention, where the passive+A-Plate is replaced by a passive −A-Plate (i.e. the optic-axis represents the fast-axis). The example shown places the optic axis as before, which inverts the output states. In the OFF-State, the combination of LC1 and the −A-Plate gives zero Rₑ and zero Rₜₕ. Unlike the previous design, a −C-Plate is further needed to drive the composite Rₜₕ to zero, as shown. But because the composite Rₜₕ of the three elements (LC1, LC2 and −A-Plate) is constant in both states, the −C-Plate retardation is also that required for the ON-State. FIG. 7B shows the ON-State, where LC1 contributes the +C-Plate retardation, and the +A-Plate of LC2 crossed with the passive −A-Plate results in a net half-wave of in-plane retardation (Rₑ).

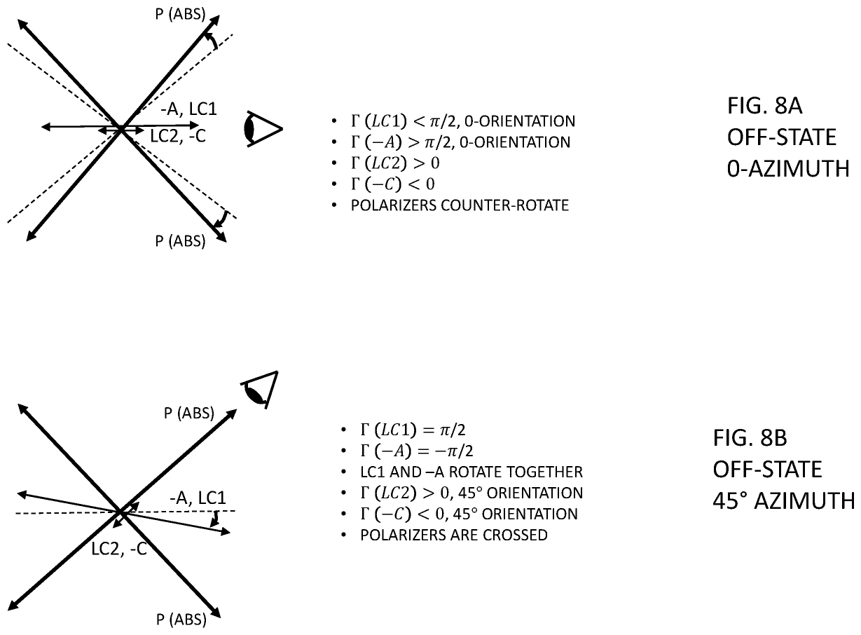

FIG. 8A shows the OFF-State layout of components for the self-compensating LC switch of the invention as observed off-normal along the O-azimuth, and FIG. 8B is that observed along the 45° azimuth. For the former, transmission is again non-zero off-normal because of geometric rotation of the polarizers (1.6%). In this design, the loss in +A-Plate retardation of LC1 is offset by an increase in the retardation of the passive −A-Plate retarder, maintaining zero net Rₑ. Additionally, the increase in retardation due to the projection of the +C-Plate retardation of LC2 is largely cancelled by the decrease in retardation due to the projection of the −C-Plate retardation of the compensator. The end result is a very small change in composite Rₜₕ.

FIG. 8B shows the OFF-State layout of components for the self-compensating LC switch of the invention as observed off-normal along the 45° azimuth. The polarizers are crossed and the projection of the +C-Plate retardation of LC2 is immaterial. Additionally, the geometric rotation of the −A-Plate and LC1 has the same handedness, and therefore the pair contributes no retardation off-normal. This feature of the invention improves the performance relative to the prior-art self-compensating switch in this state. This can be quite important when a DND is required to deliver an angle-stable filtered-state (color and luminance).

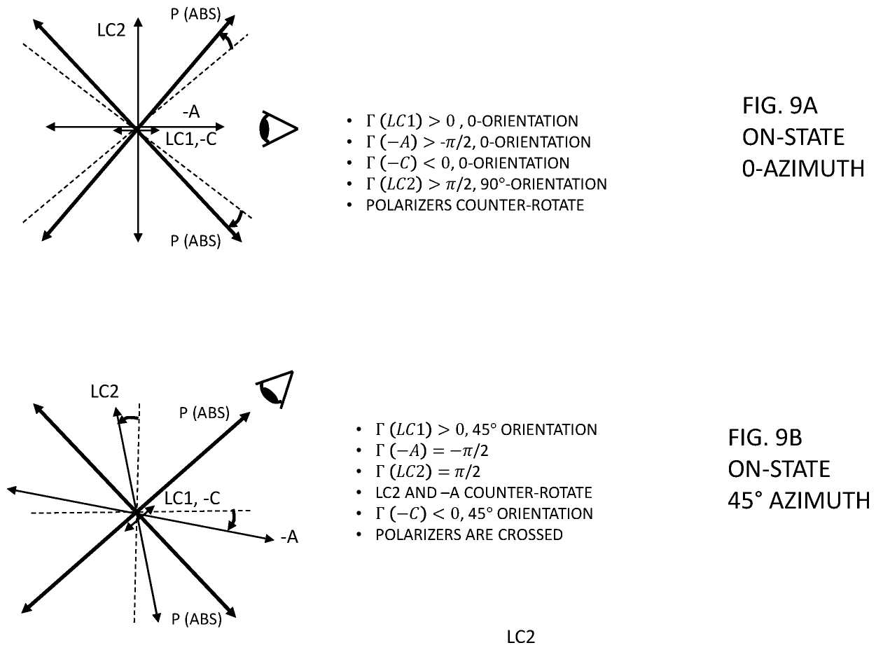

FIG. 9A shows the ON-State layout of components for the self-compensating LC switch of the invention as observed off-normal along the O-azimuth, and FIG. 9B is that observed along the 45° azimuth. As before, the polarizers are observed to counter-rotate. The combination of the +A-Plate retardation of LC2, crossed with the passive −A-Plate retardation maintains the in-plane retardation (half-wave) off-normal. The +C-Plate retardation of LC1 is eliminated by the −C-Plate retardation of the passive compensator. FIG. 9B is much the same as the previous case, where performance is exemplary apart from the counter-rotation of the LC2 slow-axis and the −A-Plate fast-axis. As usual, the retardation values are substantially maintained off-normal in this azimuth.

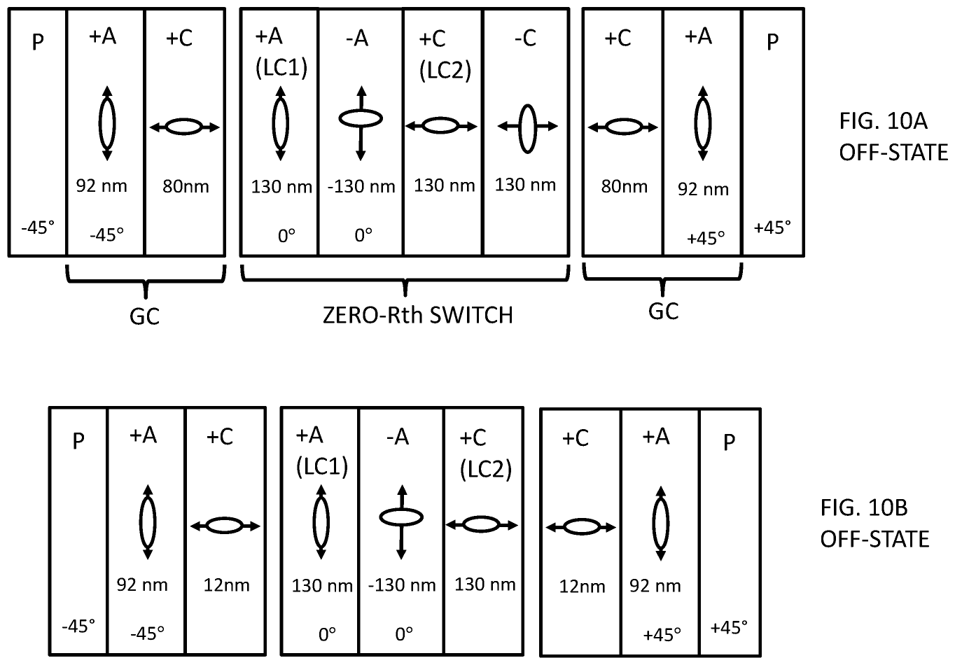

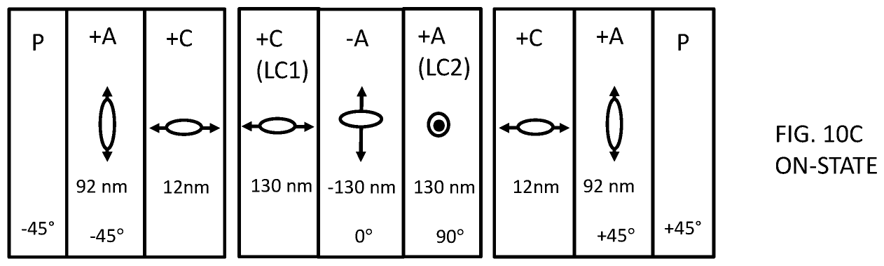

In the previous examples, nothing was done to mitigate the leakage associated with counter-rotation of the polarizer absorption axes. FIG. 10A shows the previous LC switch, with the insertion of geometric compensators (GC) on either side. Note that an alternative is to place a suitably designed GC on a single side, rather than both. In this instance, composite Rₜₕ can be maintained near-zero by placing half of the −C-Plate compensation on the opposite side of the switch, as shown. Noting that the +C-Plate retardation of each GC is directly adjacent the −C-Plate compensator allows each pair to be replaced by the net C-Plate retardation, as shown in FIG. 10B. Note that while this net 24 nm of retardation is quite small, it can have a significant impact on contrast performance when used as a shutter (2,860:1 with the C-Plates, versus 667:1 without them, at a 45° AOI at the worst-case azimuth). FIG. 10C shows the arrangement when switched to the ON-State.

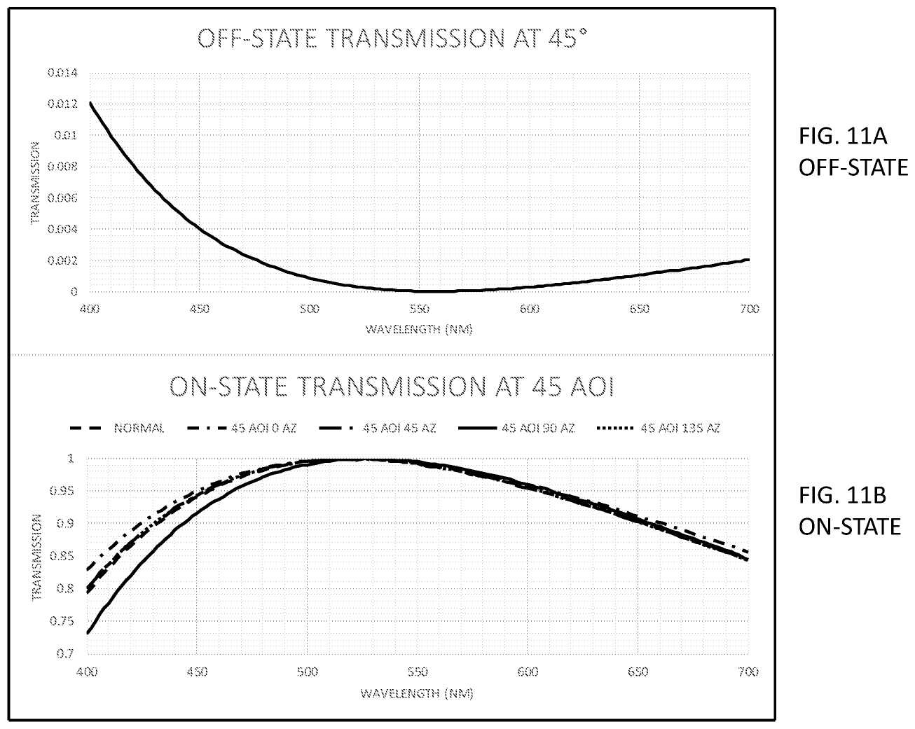

FIG. 11A shows the OFF-State spectrum of the fully-compensated polarization switch shown in FIG. 10A when used as a high-contrast light shutter. A single trace is shown for FIG. 10A because it represents the worst-case (zero-azimuth), where the transmission in the 90° azimuth is virtually identical. The leakage in the ±45° azimuth is virtually zero. FIG. 11B shows the ON-State transmission when LC1 and LC2 are both switched. This can be recognized as the transmission of a zero-order dispersionless half-wave retarder, where the center wavelength was selected to be 520 nm. The transmission at a 45° AOI is nearly identical to that at normal-incidence past approximately 500 nm. The variation in transmission at shorter wavelengths in the 0/90° azimuth is due to the breakdown in performance of the GC with angle due to phase-difference dispersion. Using these spectra, the photopically weighted contrast of the shutter was calculated to be 2,860:1. This shows that, by replacing the +A-Plate retarder of the prior art, with a −A-Plate retarder, the contrast of the invention is improved by a factor of 13X.

Four illustrative examples of shutter designs were presented. Factor 1 of the AOV limiters was eliminated from all examples by only considering A-Plate/C-Plate stacks, Factors 2 and 3 were considered in these examples, and Factor 4 will be considered in multi-stage DND configurations. To summarize, FIG. 1 showed that the AOV is limited mainly by the Rₜₕ in both states, with some contribution from geometric-rotation of polarizers, and a small ON-State distortion due to the geometric rotation of the HW A-Plate. FIG. 4 showed that Factor 2 can be substantially eliminated from both states. There remains geometric rotation of the polarizers, and geometric rotation of the retarders. The latter causes a leakage in both the OFF-State and an incremental loss in transmission in the ON-State. FIG. 7 again showed that Factor 2 can be substantially eliminated from both states. There remains geometric rotation of the polarizers, and geometric rotation of the retarders. The invention eliminates the contribution of the latter to the OFF-State, though there may be an incremental loss in transmission in the ON-State. FIG. 10 showed that Factor 2 and Factor 3 can be substantially eliminated from both states. There remains only an incremental loss in transmission in the ON-State. The final of these examples is used in some of the subsequent DND stage and filter architectures.

The invention seeks to identify DND filter structures that are angle stable and ideally provide quasi-neutral transmission states. The objective of a DND stage is to act as an all-pass filter in one state, and a filter with a wavelength/angle stable prescribed transmission in the other state. In the context of a Type 1 filter, a stage contains an input polarizer, an analyzing polarizer, one or more active LC devices, and additional retarder films as needed. There are a number of methods for producing a filtered-state in a Type 1 filter stage, including; (1) Introducing a passive bias retarder (e.g., via the A-Plate); (2) Introducing a bias retardation via the LC switches; (3) Controlling the angle between the polarizers, and; (4) Using one or more partial-polarizers. The best spectral performance from an all-pass filter occurs when the two polarizers are parallel and the structure between them vanishes. This has the additional advantage that no specific state-of-polarization is required for the filtered-state, so long as the projection onto the analyzer yields the desired transmission. For example, a one-stop filtered state can be produced by circular polarization, linear±45° polarization, or any SOP lying in the S₁/S₂ plane of the Poincare sphere.

In the parallel-polarizer configuration, the filtered state relies upon the quality of the polarization conversion by the switching structure. The required polarization conversion is substantial, being nominally equivalent to rotating a polarizer by 45° (1-Stop), 60° (2-Stops), or 76° (4-Stops), and therefore dispersion can be large if phase-difference is used to accomplish it. Specifically, the polarization conversion by the structure is likely to be wavelength-dependent, leading to a wavelength-dependent transmission. There are an infinite number of polarization transformations that can produce the desired projection of the electric field onto the analyzing polarizer. A 45°-oriented linear retarder requires the least modulation in retardation, with a reduction/increase in orientation angle requiring a larger modulation in retardation. More complex twisted structures may also produce the same end-point on the Poincare sphere. The following contains some illustrative examples using retardation switching.

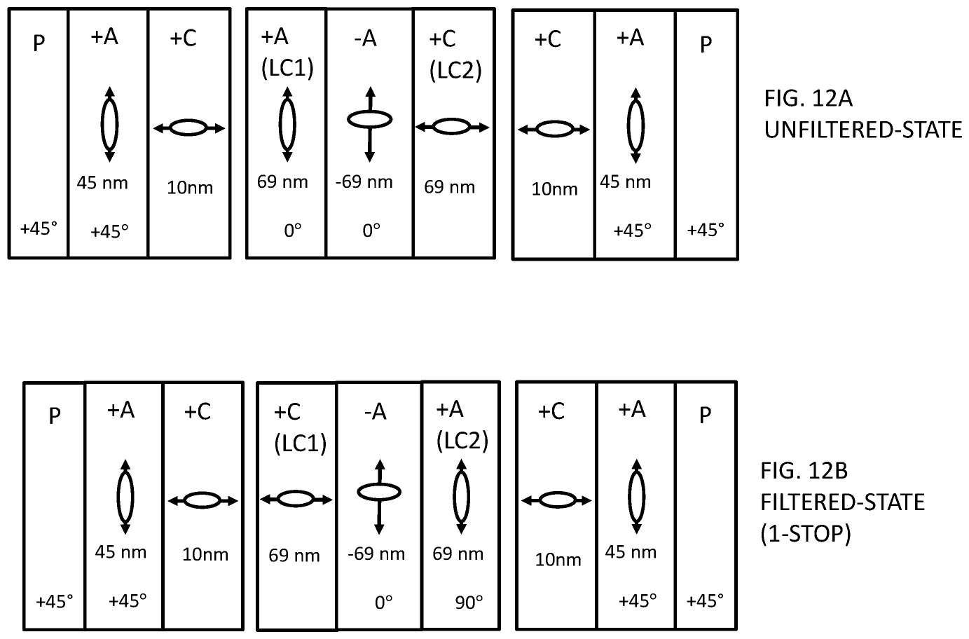

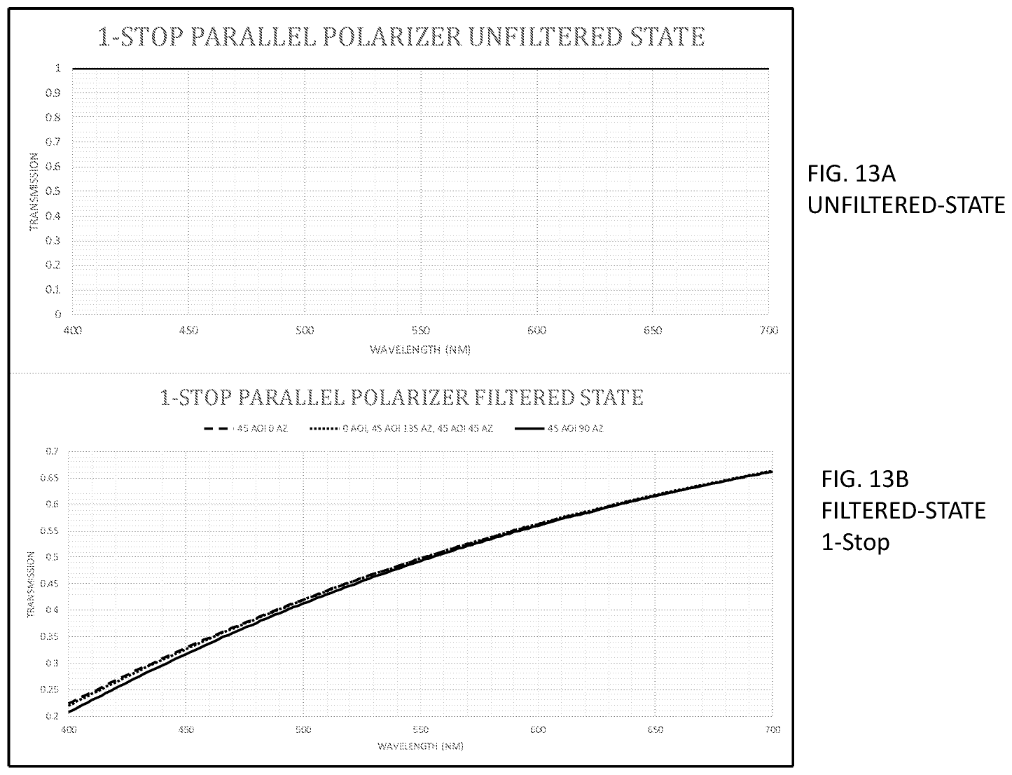

FIG. 12 shows a parallel-polarizer DND filter stage configuration in the (A) unfiltered-state, and (B) filtered-state, where density switching is accomplished using a structure that behaves as a 45° oriented linear retarder. As shown, the net Rₑ is in general zero in the unfiltered state because the retarders are matched in retardation and orientation. Given that the filtered state is generated via zero-order retardation (T=cos² Γ/2), where F is the phase difference, the 1-Stop example requires each retarder to have 69 nm of retardation to produce a net quarter-wave of retardation at 550 nm. As FIG. 12B shows, the transmission spectrum is extremely stable with AOI/AZ. However, a QW retarder has significant dispersion and the transmission is red-rich and blue-depleted. Were this extended to 2-Stops, the transmission in the short blue approaches zero, and for higher attenuation, the blue band may be substantially blocked. This highlights an issue that can occur when using retardation to implement a DND with parallel polarizers.

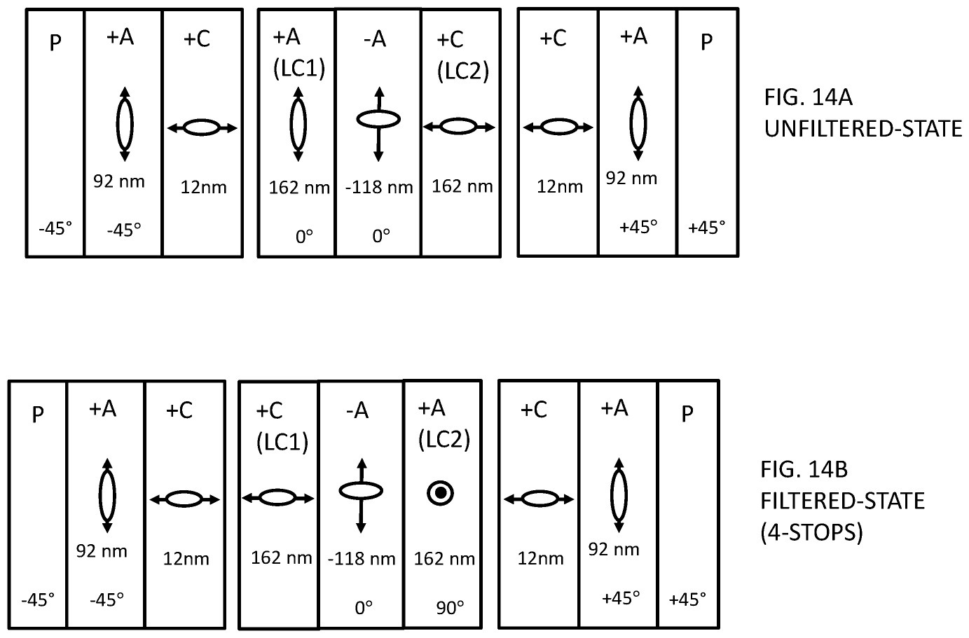

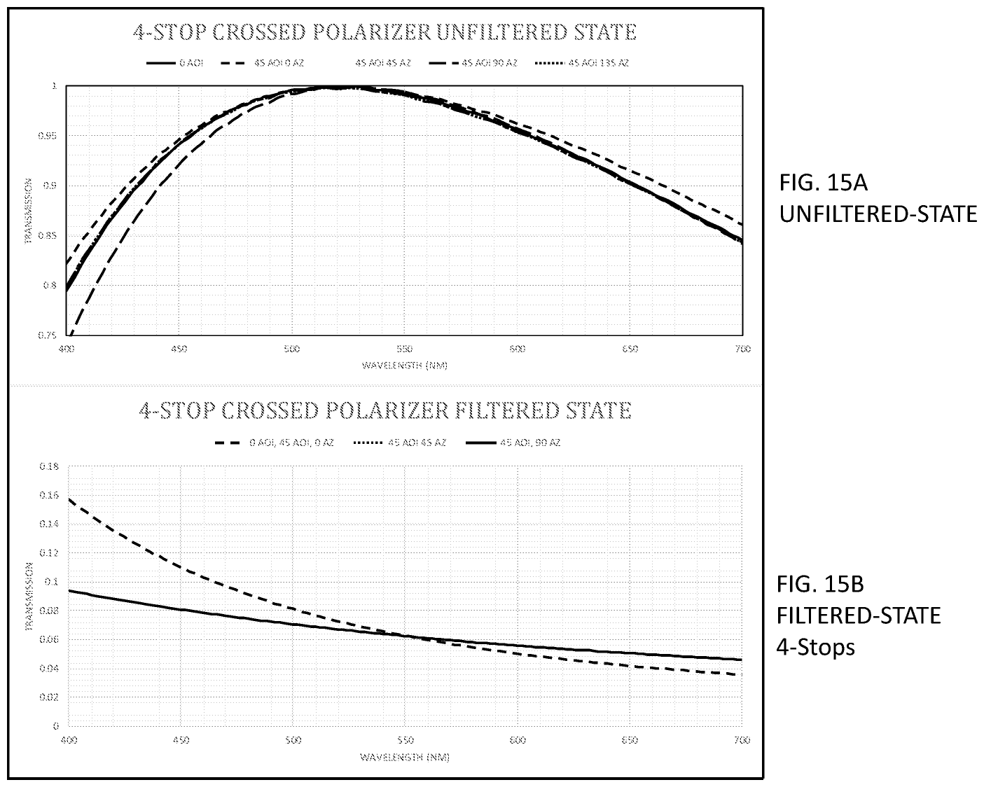

An alternative to the above approach is to use crossed polarizers, where the unfiltered-state requires conversion of all visible wavelengths (ideally) to the orthogonal SOP. If accomplished using a zero-twist retarder, the transmission peaks at the half-wave wavelength, with significant roll-off at shorter/longer wavelengths. Typically, some color balance between blue and red is sought, which tends to result in a green-tinted transmission. The filtered state is thus produced by a relatively small Rₑ value, which can have the benefit of showing lower wavelength-dependence relative to the parallel-polarizer case. The design equations for the crossed-polarizer case can be given by

$${Γ}_{L C} = \frac{{Γ}_{U} + {Γ}_{F}}{2} \\ {Γ}_{A} = \frac{{Γ}_{U} - {Γ}_{F}}{2}$$

Where Γ_{LC}, Γ_{A}, Γ_{U}, Γ_{F} are the retardation values for the (matched) liquid-crystal devices, the passive −A-Plate retarder, and the composite retardation in the unfiltered-state and the filtered-state, respectively. These equations were used to generate the 4-Stop design shown in FIGS. 14A/B for 4-Stops of attenuation. FIGS. 15A/B show the transmission spectra for the design of FIGS. 14A/B at normal incidence and at 45° AOI for several key azimuth angles. As in the shutter case of FIG. 11B, the unfiltered spectrum of FIG. 15A is stable with angle, with the exception of the angle-dependent dispersion of the GC. Because the retardation is short relative to half-wave, the filtered-state is now blue-rich. However, there is no risk of red-blocking since it would require driving the composite Rₑ to zero. The transmission of FIG. 15B thus reflects both the phase-difference dispersion and the impact of the GC dispersion that occurs over angle.

While the parallel and crossed DND stage configurations presented show good spectral stability with respect to angle, the tint can be problematic particularly in multi-stage configurations. For instance, a three-stage crossed-polarizer configuration has a maximum density given by the product of three blue-rich spectra. The compounding effects of this can produce a nonuniformity in transmission between blue and red wavelengths that may be deemed unacceptable. If, for example, the filter has 7-stops of attenuation in the green, with 4 in the blue and 10 in the red, it is likely that a correction in post-production is not a viable option. Alternatively, a parallel-polarizer stage could be combined with a crossed-polarizer stage, such that the highest density state is the product of a red-rich spectrum with a blue-rich spectrum, therefore mitigating the compounding effects. This can be regarded as an example of inter-stage compensation to improve color performance. A better solution, of course, would be to have DND stages that produce more neutral output spectra.

One of the challenges in DND design involves dealing with the wavelength dispersion of retarders. If it were feasible to make active LC devices with the proper reverse birefringence dispersion, filter transmission spectra could be relatively flat in both unfiltered and filtered states. Currently, it is not practical for a variable birefringence LC device to switch the same phase-retardation for all wavelengths of the visible, and consequently, one or both states of a DND stage may show some chromatic behavior. It is known that retarders can be combined to effectively engineer a reverse-dispersion in a polarization transformation. Koester (C. Koester, “Achromatic combinations of half-wave plates”, J Opt Soc Am, 49, 4, 405-409 (1959)) showed that a pair of half-wave retarders can produce a linear polarization transformation with lower wavelength-dependent than that from a single half-wave retarder. It is also known that there can be an accumulation of Rₜₕ in such designs, and as such, the AOV can be diminished for the sake of achromatizing a polarization transformation. One of the requirements of the self-compensating LC switch is that it requires an independent pair of LC devices for constant Rₜₕ, but the pair can be leveraged to serve a second purpose: achromatizing the ON-State transformation.

The invention recognizes that the pair of LC devices driven anti-phase and digitally, is functionally an in-plane switch with a constant Rₜₕ. The configuration allows arbitrary switching between two in-plane orientations and two retardation values. The prior art shows that an in-plane half-wave retardation switch (ferroelectric liquid crystal, FLC) combined with passive A-Plate retarders can function as compound elements with engineered reverse-dispersion. In one configuration (Sharp, U.S. Pat. No. 5,870,159, the contents of which are incorporated herein by reference), the FLC is oriented with slow-axis crossed with that of a passive+A-plate, yielding zero composite Rₑ. When switched to the other orientation, the structure behaves as an achromatic (Koester) rotator. Similarly, an FLC device flanked by +A-plates (Sharp U.S. Pat. No. 5,658,490, the contents of which are incorporated herein by reference) can function as an achromatic compound retarder with switchable slow-axis orientation. The FLC devices can be replaced by a pair of nematic switches according to the invention, enabling structures with zero Rₜₕ and an achromatic transformation.

In a general achromatic rotation, the angles of the two+A-Plate retarders for a rotation angle of a can be given by

$${α}_{1} = \frac{α}{4} + ɛ \\ {α}_{2} = \frac{3 α}{4} - ɛ$$

respectively, where ε is a small angle that can be used to adjust the coverage and flatness of the spectrum. In general, the above shows that the polarization rotation given by a pair of half-wave retarders with orientation α₁ and α₂ is 2(α₂−α₁). In the case where the passive retarder is a negative A-Plate, an additional 90° of rotation is needed for that element

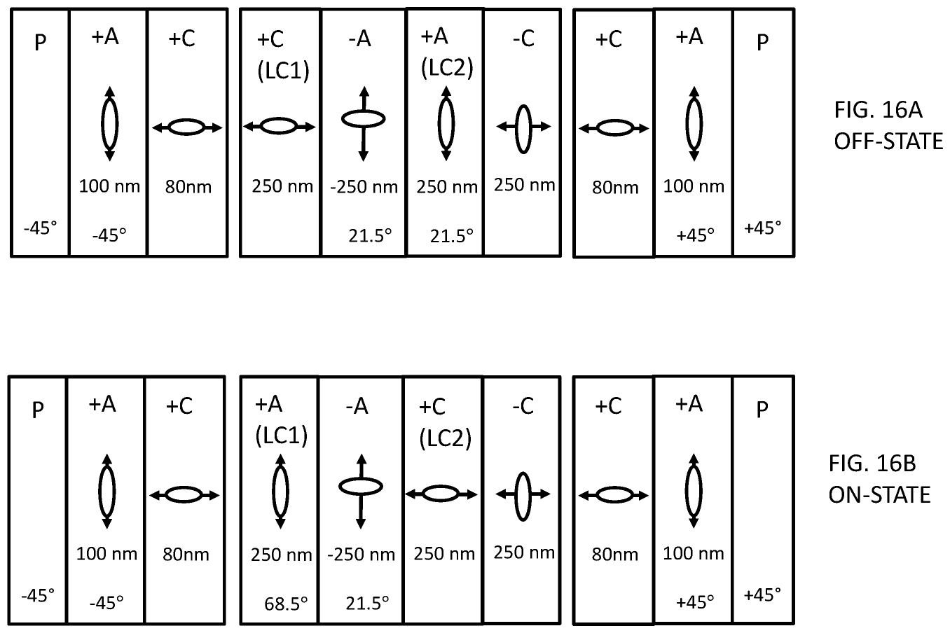

FIG. 16 shows a wide-angle achromatic rotator-switch of the invention used as a light-shutter. In this case the polarizers are crossed, so the ON-State requires an achromatic 90° rotation with orientations defined above. All of the elements have a half-wave of retardation (at 500 nm), where as before, the passive retarder is a −A-plate. In FIG. 16A, LC2 is parallel to the −A-plate retarder, with LC1 compensated by a matched −C-Plate retarder, producing zero net Rₑ. When switched to the ON-State (FIG. 16B), LC1 and the −A-Plate form an achromatic rotator, where LC2 is compensated by the −C-Plate retarder.

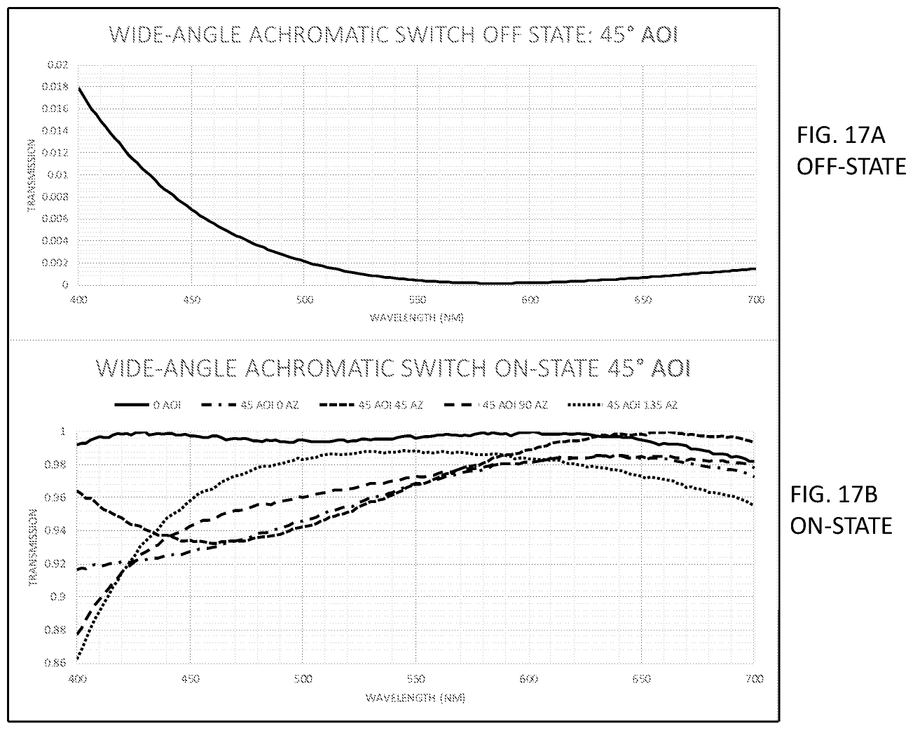

FIG. 17A shows the OFF-State spectrum of the fully-compensated polarization switch shown in FIG. 16A when used as a high-contrast light shutter. A single trace is shown for FIG. 17A because it represents the worst-case (zero-azimuth), where the transmission in the 90° azimuth is virtually identical. The leakage in the ±45° azimuth is virtually zero. FIG. 17B shows the ON-State transmission when LC1 and LC2 are both switched. Comparing to FIG. 11B, the normal incidence transmission is much more neutral, owing to the benefits of the achromatic transformation of the two half-wave retarders. FIG. 17B also shows some distortion in the transmission function over angle, though the tint is generally lower than that of the zero-order half-wave retarder switch.

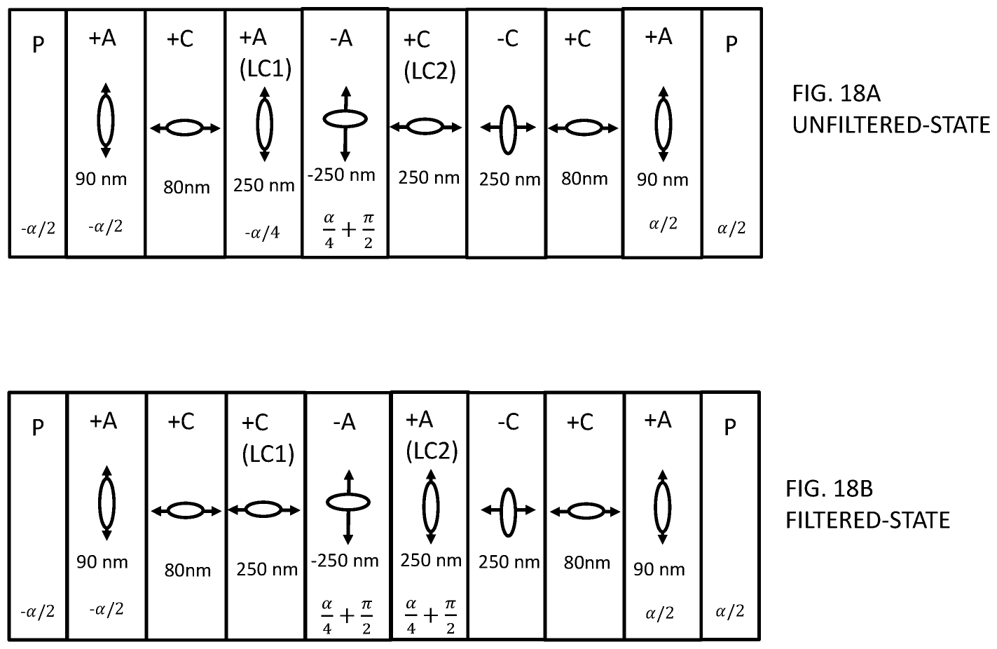

FIG. 18 incorporates the achromatic rotator switch into a DND filter stage architecture. In this case, preference is given to the performance of the filtered state using two mechanisms: (1) The combination of the LC2+A-Plate and the passive −A-Plate produces an angle-stable output and, (2); by rotating the analyzer, a neutral filtered-state is produced when the structure between the polarizers vanishes (with the exception of the GCs). The density requirement is met when the analyzer is oriented according to, T=cos² α, where a is the angle between the polarizers, which in-turn gives the rotation angle required to produce a highly efficient unfiltered-state.

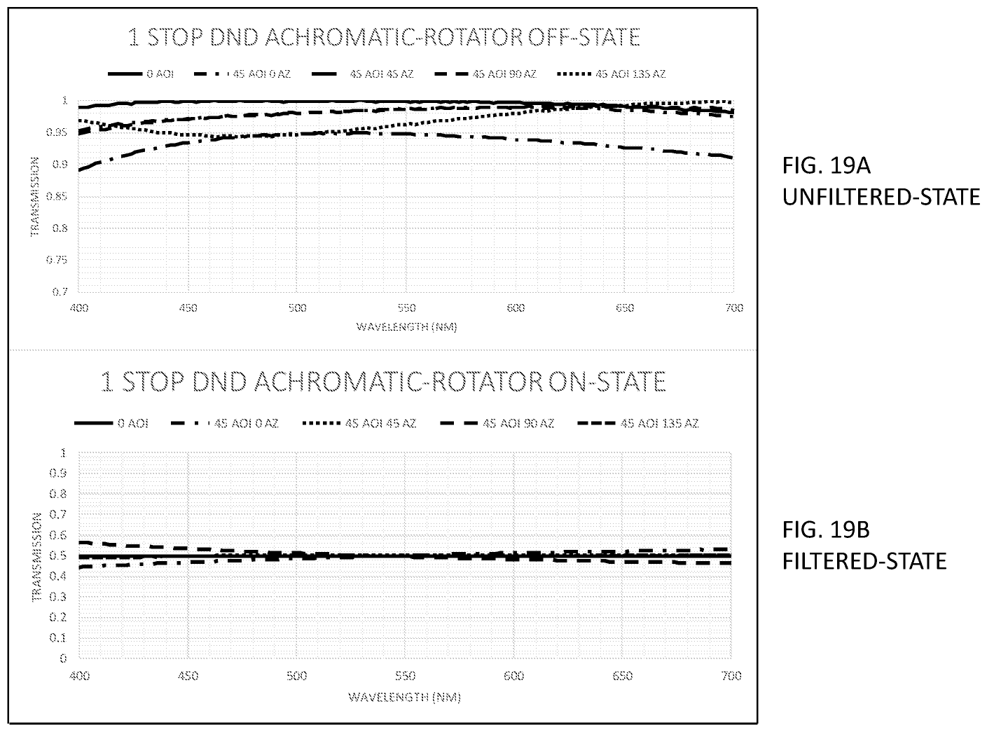

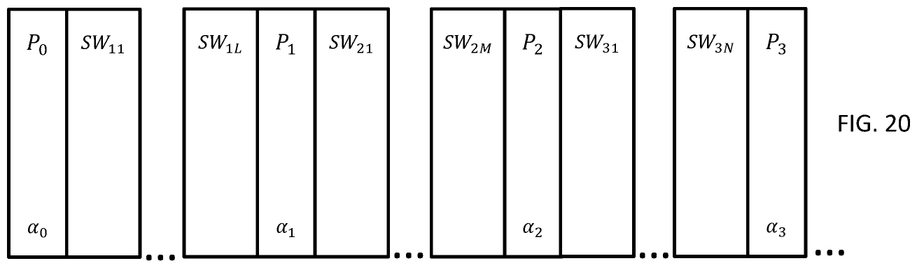

FIG. 19 shows the transmission spectra for the design of FIG. 18 at normal incidence and at 45° AOI for several key azimuth angles based on a 1-Stop DND stage. FIG. 19A shows a very flat output at normal incidence, with relatively stable color over incidence angle out to 45° AOI. The filtered transmission of FIG. 15B is very flat at normal-incidence, and shows excellent stability at large AOI through the mid-part of the spectrum. As before, some distortion in the blue/red can occur due to the dispersion in phase of the GC. To summarize, this DND stage has minimal issues associated with Factors 1, 2 and 3, with the achromatic benefits of an engineered reverse-dispersion that is angle-stable. FIG. 20 shows a general block-diagram for a multi-stage DND filter of the invention, including a plurality of independently driven switches and a plurality of stages. Each stage contains a total of (L, M, N . . . ) switches, which in principle allows 2^{(L+M+N . . . )} output states. By obtaining additional outputs from a particular stage, it may be feasible to omit polarizers and associated light loss and complexity.

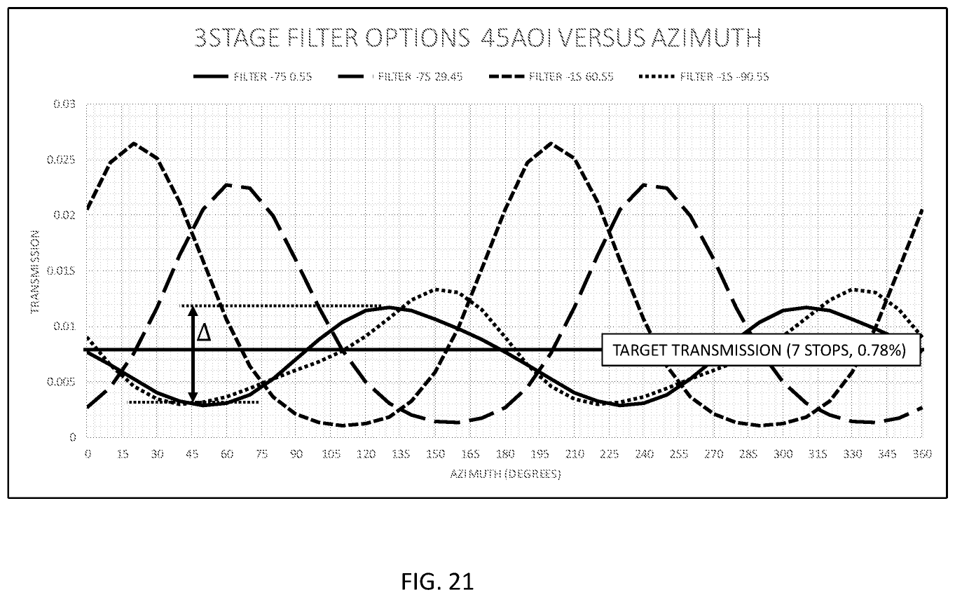

Consider the specific example where there is only one switch per stage, and each stage conforms to the design shown in FIG. 18. In this example, the three stages have filtered states with 1-Stop, 2-Stops, and 4-Stops of attenuation, corresponding to analyzer orientations of 45.0°, 60.0°, and 75.55° relative to their input polarizer. Initially, assume that the switching structures between the polarizers all vanish at normal incidence in the highest density (in this case, 7-stops). Since the polarizers in each stage are not crossed, it remains to determine the specific arrangement of polarizers that produces the best performance over angle. The contrast polar plot of the DND filter is given by the product of the polar plots associated with each stage, and as such, the order of stages may be inconsequential. However, there are still some options in polarizer arrangement. Assuming that the first polarizer has orientation α₀=0, and that the second corresponds to the 1-Stop stage α₁=45.0° (without loss of generality), that leaves an arbitrary relative handedness associated with the third and fourth polarizers (in this case arbitrarily selected to be the 2-Stop and 4-Stop stages). For a general DND filter with N-stages using the FIG. 18 architecture, there are 2^{N-1} options for polarizer orientations. The order of stages can also be switched, where (e.g.) the four-stop stage is in the middle of the structure. In this 3-stage example, options for polarizer orientation correspond to (0, 45.0°, −75.0°,0.55°), (0, 45.0°, −75.0°,29.45°), (0, 45.0°, −15.0°,60.55°), and (0, 45.0°, −15.0°, −90.55°). FIG. 21 shows the transmission for each of these examples in the 7-Stop state at 45° AOI, as a function of azimuth. It shows that the lowest modulation in transmission (solid line) occurs in the “fan” arrangement, as described in a previous invention (Sharp and McGettigan US 20180259692, the contents of which are incorporated herein by reference).

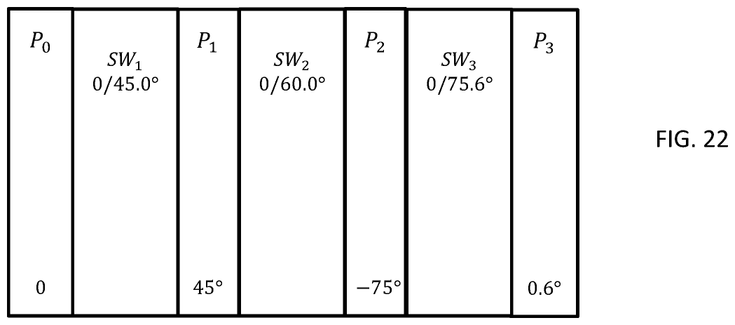

The architecture with the best performance, shown in FIG. 22, represents an embodiment of inter-stage compensation of the invention. FIG. 21 shows that the transmission varies from a low of 0.29%, to a high of 1.14%, with a target of 0.78%, corresponding to a peak-valley variation of 2.0 stops, at a set-point of 7.0 stops. This is not a trivial nonuniformity, but it should be benchmarked against the performance of a single stage: The 4-Stop stage alone gives a low of 1.66% and a high of 13.17%, corresponding to a peak-valley variation of 3.0 Stops at a set-point of 4.0 Stops. This verifies the effectiveness of inter-stage compensation, as the nonuniformity at 7-Stops is significantly lower than it is at 4-Stops with a single stage. In the event that a lower transmission nonuniformity is required, GC elements can be added to one or more of the filter stages as shown in FIG. 18.

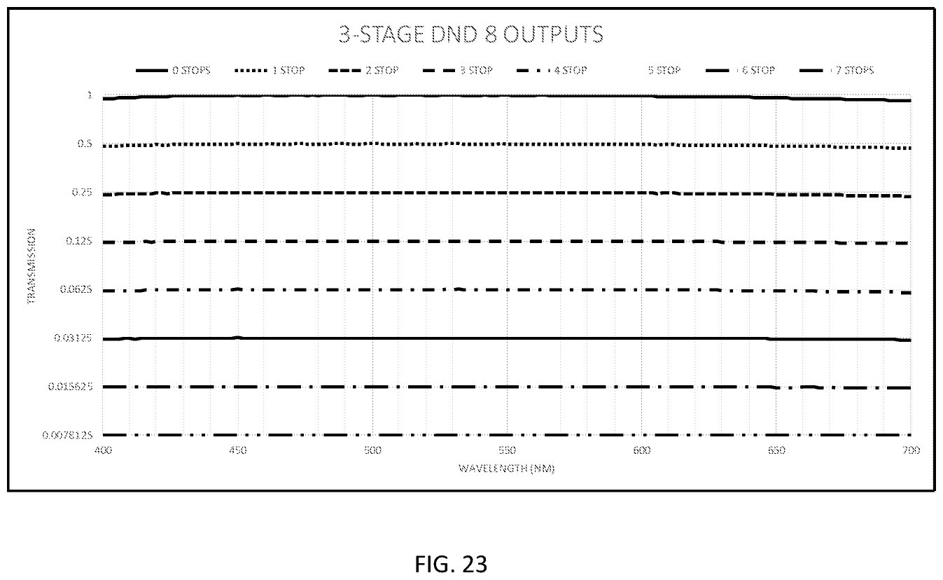

Normal-incidence transmission spectra for filtered and unfiltered outputs were generated for each of the states of the previous example, using the design of FIG. 18 for 1, 2, and 4-Stops. Each of the 8-outputs of the FIG. 22 architecture was generated by multiplying these spectra in the appropriate combinations. The result, shown in FIG. 23, indicates that each output is neutral, and that the geometric series of attenuation from each stage can produce arithmetic steps in attenuation DND. As FIG. 19 shows for 1-Stop, which has been verified to be consistent for 2-Stop and 4-Stop designs, it is reasonable to consider that the DND spectra are further stable with incidence angle.

According to the teachings herein, the optic axis orientation for each of the retarders of a zero Rₜₕ switch, including two LC devices and a passive retarder, is arbitrary. The anti-phase switching gives a constant Rₜₕ which is removed as needed with film compensation, per the invention. The film compensation can be done with the addition of a C-plate retarder, or the associated Rₜₕ can be incorporated into a biaxial film that also includes the required Rₑ. This can be illustrated by examples.

The previous example illustrated a zero-Rₜₕ switch that provides either an isotropic state or an achromatic rotator state. But the switch need not be isotropic in one state, and could for example be an achromatic rotator in both states. The previous equations give the slow-axis orientations for an achromatic polarization rotation of α. Consider the case where a first liquid crystal half-wave retarder (LC1) and a passive half-wave+A-Plate retarder have orientations, α₁=θ₁/4 and, α₂=3θ₁/4, respectively, where θ₁ is a first achromatic polarization rotation angle. When LC1 is driven to a C-Plate state, a second polarization transformation is produced by the action of the passive A-plate retarder in combination with the second liquid crystal half-wave retarder (LC2), which is now in the A-Plate state per the invention. The passive A-Plate retarder can now be considered to form the first retarder required for a second achromatic rotation, where the second rotation angle is θ₂=3θ₁. Per the above equations, the orientation of LC2 is therefore, α₃=9θ₁/4. Functionally this device has a bias rotation angle of θ₁, which when switched, further rotates the polarization by 2θ₁. This could be used as-is, or in combination with one or more passive retarders that removes the bias rotation.

Consider the example of the previous achromatic rotator switch receiving a linear polarization along 0° that is required to switch the output polarization between linear polarization states with an orientation of +45° and −45° (=135°). According to the design equations, allowing for small orientation changes (i. e. ε) to modify the spectral coverage, this can be accomplished using slow axis orientations of α₁=12.0°, α₂=33.4°, and α₃=−80.0°. Assuming dispersionless half-wave retarders with a 500 nm center wavelength, this gives two transformations, with ideal achromatic rotations of ±45° at two wavelengths. These spectra overlap at wavelengths of approximately 440 nm and 580 nm. As in the design with a zero-Rₑ state, this switch has zero intrinsic Rₜₕ when the passive retarder is a positive A-Plate, and requires the addition of a passive −C-Plate half-wave when the passive retarder is a negative A-Plate.

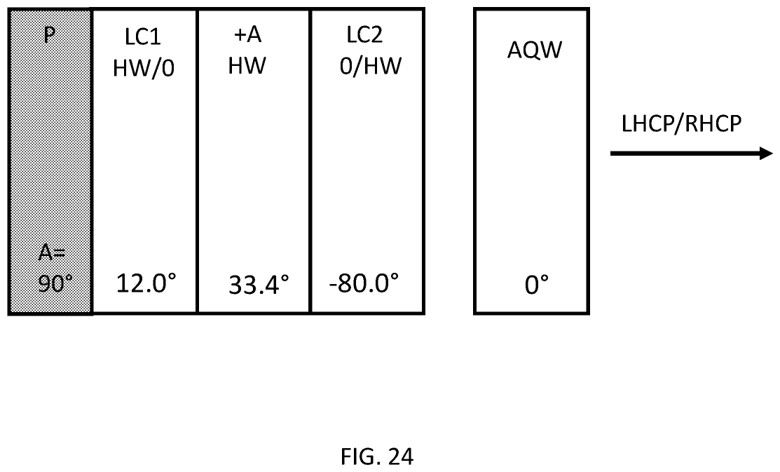

A device that switches between ±45° linear polarization, with wide acceptance angle, and wavelength insensitivity can be used for applications such as sequential stereoscopic 3D with linear polarizer eyewear. Also, this switch can be combined with other passive polarization functional elements to produce other outputs. For example, following this switch with an achromatic quarter-wave retarder with zero-orientation gives a wide-angle achromatic circular polarization (left/right) handedness switch, as shown in FIG. 24. This switch can also be incorporated into a DND filter stage, with the understanding that it has a relatively balanced sensitivity to incidence angle. This can be contrasted with the rotator switch with a zero-Rₑ state, where it was shown that a very angle-stable output can be produced when using a passive negative A-Plate (i.e. FIG. 18).

As indicated previously, there are other ways to create a desired filtered state from a Type 1 filter stage. Previous examples showed a bias retardation introduced via a difference between identical retardation LCs and the passive A-Plate. It could also be introduced via a difference between the retardation of the LC devices, with similar performance results. A DND filter can also be realized using stages with partial polarizers. A partial polarizer has a prescribed absorption along the absorbing axis, such that when crossed with a high contrast, a desired filtered state can result. Stages with different partial polarizer absorption values can enable multiple density states, much like the examples given. However, an increase in transmission may occur because of the reduced projection along the absorbing axis off-normal in one azimuth. Similarly, a decrease in transmission may occur in the orthogonal direction due to increased pathlength. This may be mitigated by providing a partial polarizer with absorption along the thickness direction.

Filters of the invention can also be realized using Type 2 structures. In this case, an active polarizer (e.g., a guest-host LC device) can be used to replace the combination of a passive analyzer and a polarization switch. Some of the same factors described to maximize the AOV apply to a Type 2 structure. Oblique anisotropy is minimized by digitally switching between an in-plane polarizer and a thickness-direction polarizer. Geometric compensation can then be introduced as described previously to improve the AOV in the filtered state.

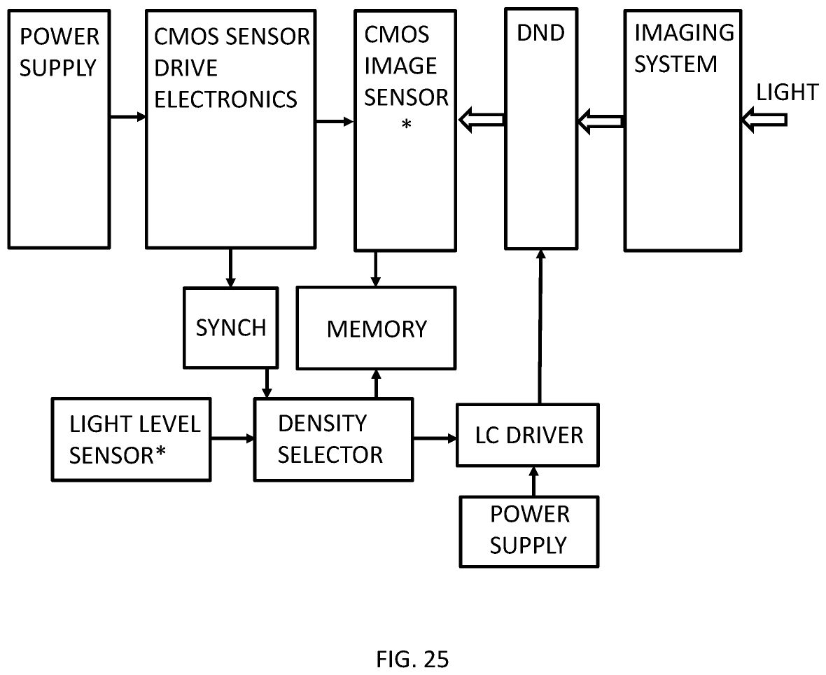

FIG. 25 shows a block-diagram describing use of a DND in a system. In this arrangement, the DND is positioned between an imaging system (a camera lens), and a CMOS imager, though it could also proceed the lens in the optical train. The DND filter is actuated by an LC-driver that supplies the appropriate DC-balanced logic state to the LC devices to produce the desired density. Should an LC-pair of a switch be of a common type (e.g., both ECB, or both VA), anti-phase outputs are required. The driver may supply 0-volts or a voltage of sufficient amplitude to virtually eliminate any oblique-anisotropy. It is also possible to use cells of different type (e.g., a VA with an ECB), such that a single output modulates the structure between +A and +C configurations. In the event that the voltage amplitude available is insufficient to eliminate the splay in the driven cells, the combination of a VA and ECB cell can be assigned to optimize the filtered-state when both are at 0-volts. In this case, the AOV may be limited by the nonuniformity of the unfiltered state subject to limitations in voltage amplitude. The DND drive may be synchronized with the image capture system via a synch signal. A light-level sensor (either auxiliary, or using the CMOS imager) can provide the information needed to select the appropriate DND density, enabling a closed-loop system. Density settings can be recorded in memory, facilitating any look-up tables recorded to correct for luminance and color nonuniformity.

A DND filter and the zero-Rₜₕ achromatic switches of the invention can be used in a number of communications, avionics, military, medical, and consumer applications. Aperture sizes can be small or very large, owing to the use of display materials and devices. The sensor may be a single-pixel device, an array sensor, or the human eye. For the latter, the system can be near-eye (head mounted), in-vehicle (e.g., an automotive heads-up display), direct-view, or a virtual cockpit (e.g., viewing the camera feed from a drone using a virtual reality goggle). The system may operate in the UV, visible, near-infrared, or infrared spectra. Basically, the DND of the invention is appropriate for any application requiring agile changes in transmission with no moving parts. It is particularly well suited to producing a plurality of density outputs that are stable over a very broad range of incidence angles.

More generally, an exemplary DND stage shown in FIG. 18, with analyzer omitted, is a wide-angle achromatic polarization rotator switch, with arbitrary rotation angle. In FIG. 18, it is combined with an analyzer, which is a specific example of a device with orthogonal linear eigen-polarizations. Switching between orthogonal polarizations (i.e. α=90°) thus produces a wide-angle achromatic shutter. But more generally, the analyzer can be replaced with other devices with orthogonal eigen-polarizations. This includes reflective polarizers (e.g., wire-grid or multi-layer stretched films), polarizing beamsplitters, geometric-phase devices such as GP lenses and beamsteerers (which may additionally require a passive quarter-wave retarder), retarder-stack wavelength-selective filters, pleochroic dye color polarizers, polarization functional nano-structures, and polarization-functional meta-materials. Applications include dimmers, switchable pathlength devices, switchable focal-length devices, and agile digital beam-directors. These devices are applicable to a broad range of systems, including head-mounted displays for military/avionics, virtual-reality and augmented-reality, automotive, drones, action-sports cameras, DSLR, broadcast cameras, and cinematography.

1. A zero-Rₜₕ achromatic polarization rotator switch, comprising:
a first linear polarizer with absorption axis orientation of 0° or 90°;
a first liquid crystal half-wave retarder switch (LC1) with slow-axis orientation α₁;
a second liquid crystal half-wave retarder switch (LC2) with-slow axis orientation α₂; and
a passive positive half wave A-plate retarder with slow-axis orientation α₃;
wherein the liquid crystal switches are electrically driven out of phase, such that LC1 is an A-plate when LC2 is a C-plate (State 1), and LC1 is a C-plate when LC2 is an A-plate (State 2);
wherein (α₃−α₁)≠±90°.

2. A polarization rotator switch as defined in claim 1, wherein α₁=(α₂±90°) or α₃=(α₂±90°).

3. A polarization rotator switch as defined in claim 1, wherein the achromatic polarization switch has a polarization rotation of θ=2(α₂−α₁) in State 1 and has zero rotation in State 2.

4. A polarization rotator switch as defined in claim 3, wherein α₁=(θ/4+ε) and α₂=(3θ/4−ε), wherein ε is an angle smaller than 2°.

5. A polarization rotator switch as defined in claim 4, further including an analyzing polarizer with absorption axis orientation of (θ+90°), such that the transmission is unity in State 1 and cos²θ in State 2.

6. A polarization rotator switch as defined in claim 5, wherein θ=90°.

7. A polarization rotator switch as defined in claim 5, further including an A-Plate/C-Plate geometric compensator.

8. A polarization rotator switch as defined in claim 7, wherein the A-Plate and C-Plate pathlength difference are between 70 nm and 140 nm.

9. A polarization rotator switch as defined in claim 1, wherein the achromatic rotator switch has non-zero polarization rotation angles of θ₁=2(α₂−α₁) in State 1 and θ₂=2(α₃−α₂) in State 2.

10. A polarization rotator switch as defined in claim 9, wherein θ₂=3θ₁.

11. A polarization rotator switch as defined in claim 9, wherein α₁=θ₁/4 and α₂=3θ₁/4 and α₃=9θ₁/4.

12. A polarization rotator switch as defined in claim 9, wherein the achromatic rotator switch is followed by a quarter-wave retarder with orientation 0° or 90° to give a circular handedness-switch.

13. A zero-Rₜₕ achromatic polarization rotator switch, comprising:
a first linear polarizer with absorption axis orientation 0° or 90°;
a first liquid crystal half-wave retarder switch (LC1) with slow-axis orientation α₁;
a second liquid crystal half-wave retarder switch (LC2) with-slow axis orientation α₂;
a passive negative half-wave A-plate retarder with slow-axis orientation α₃;
a passive negative C-Plate half-wave retarder;
wherein the liquid crystal switches are electrically driven out of phase, such that LC1 is an A-plate when LC2 is a C-plate (State 1), and LC1 is a C-plate when LC2 is an A-plate (State 2); and
wherein (α₃−α₁)≠±90°.

14. A polarization rotator switch as defined in claim 13, wherein α₁=α₂ or α₃=α₂.

15. A polarization rotator switch as defined in claim 13, wherein the achromatic polarization switch has a polarization rotation of θ=2(α₂−α₁) in State 1 and has zero rotation in State 2.

16. A polarization rotator switch as defined in claim 15, wherein α₁=(θ/4+ε) and α₂=(3θ/4−ε), wherein ε is an angle smaller than 2°.

17. A polarization rotator switch as defined in claim 16, further including an analyzing polarizer with absorption axis orientation of (θ+90°), such that the transmission is unity in State 1 and cos²θ in State 2.

18. A polarization rotator switch as defined in claim 16, wherein θ=90°.

19. A polarization rotator switch as defined in claim 17, further including an A-Plate/C-Plate geometric compensator.

20. A polarization rotator switch as defined in claim 19, wherein the A-Plate and C-Plate pathlength difference are between 70 nm and 140 nm.

21. A polarization rotator switch as defined in claim 13, wherein the achromatic rotator switch has non-zero polarization rotation angles of θ₁=2(α₂−α₁) in State 1 and θ₂=2(α₃−α₂) in State 2.

22. A polarization rotator switch as defined in claim 21, wherein θ₂=3θ₁.

23. A polarization rotator switch as defined in claim 21, wherein α₁=θ₁/4 and α₂=3θ₁/4 and α₃=9θ₁/4+90°.

24. A polarization rotator switch as defined in claim 23, wherein the achromatic rotator switch is followed by a quarter-wave retarder with orientation 0° or 90° to give a circular handedness-switch.

25. A two-stage digital neutral density (DND) filter, comprising:
a first neutral polarizer with absorption-axis orientation θ₁;
a second neutral polarizer with absorption-axis orientation θ₂, wherein the angle between θ₂ and θ₁ is β₁ giving transmission cos²β₁;
a third neutral polarizer with absorption-axis orientation θ₃, wherein the angle between θ₃ and θ₂ is β₂ giving transmission cos²β₂, wherein β₂ is different from β₁;
a first liquid crystal achromatic rotator switch (LCAR1) between the first and second neutral polarizers; and
a second liquid crystal achromatic rotator switch (LCAR2) switch between the second and third neutral polarizers;
wherein LCAR1 has zero in-plane retardation in State 1, and polarization rotation β₁ in State 2;
wherein LCAR2 has zero in-plane retardation in State 3, and polarization rotation β₂ in State 4;
wherein each of the four voltage states can be independently selected to give four unique transmission levels.

26-39. (canceled)
